(19) United States
(12) Patent Application Publication
(10) Pub. No.: US 2025/0303377 A1
(43) Pub. Date: Oct. 2, 2025

(54) THERMAL JACKET FOR SMALL VOLUME MIXING DEVICE

(71) Applicant: Cytiva US LLC, Marlborough, MA (US)

(72) Inventors: Adam Malone, Marlborough, MA (US); Andrew Elliott, Marlborough, MA (US); Daniel Dorval, Marlborough, MA (US); Carter Roche, Marlborough, MA (US); Ketan Watkar, Marlborough, MA (US)

(21) Appl. No.: 18/624,888

(22) Filed: Apr. 2, 2024

(51) Int. Cl. B01F 35/91; B01F 33/453; B01F 35/95

(52) U.S. Cl. CPC B01F 35/91; B01F 33/453; B01F 35/95

(57) ABSTRACT

Provided herein is a jacketed mixing vessel housing, comprising: (a) three jacketed side walls, each of the three jacketed side walls connected to at least one of the other jacketed side walls, each of the jacketed side walls defining an interior cavity, wherein each of the interior cavities is in fluid connection with the others; (b) a base supporting the three jacketed side walls at a bottom side of the three jacketed side walls; (c) an inlet port on the bottom side of one of the jacketed side walls in fluid connection with the interior cavity; and (d) an outlet port on one of the jacketed side walls in fluid connection with the interior cavity at a top side of the interior cavity; wherein the bottom side of the jacketed wall side wall containing the inlet slopes downwardly in a direction towards the inlet port, and wherein the three interior cavities of the three jacketed side walls are configured such that the three interior cavities are substantially filled by a fluid entering the jacketed mixing vessel housing before the fluid reaches the outlet port.

### BACKGROUND

Mixing vessels are mounted to mixer bases for use and have many applications, including in particular in the field of bioprocessing. However, different mixing vessels have different shapes and/or configurations and can require specialized mixer bases and other equipment for use. There exists a need for improved bioprocess mixer systems which are capable of rapid mixing of a wide range of volumes of process fluids, preferably with a small laboratory footprint which are easy to use by an operator.

The present disclosure provides for ameliorating at least some of the disadvantages of the prior art. These and other advantages of the present invention will be apparent from the description as set forth below.

### SUMMARY OF THE INVENTION

An embodiment of the instant disclosure is a jacketed mixing vessel housing, comprising: (a) three jacketed side walls, each of the three jacketed side walls connected to at least one of the other jacketed side walls, each of the jacketed side walls defining an interior cavity, wherein each of the interior cavities is in fluid connection with the others; (b) a base supporting the three jacketed side walls at a bottom side of the three jacketed side walls; (c) an inlet port on the bottom side of one of the jacketed side walls in fluid connection with the interior cavity; and (d an outlet port on one of the jacketed side walls in fluid connection with the interior cavity at a top side of the interior cavity; wherein the bottom side of the jacketed wall side wall containing the inlet slopes downwardly in a direction towards the inlet port, and wherein the three interior cavities of the three jacketed side walls are configured such that the three interior cavities are substantially filled by a fluid entering the jacketed mixing vessel housing before the fluid reaches the outlet port.

### BRIEF DESCRIPTION OF THE DRAWINGS

FIG. 1A shows a frontal view of a bioprocess mixer system according to an embodiment described herein which includes an enclosure body encompassing a jacketed mixing vessel housing which encloses a mixing vessel, the mixing vessel mated to a mixer base assembly with a connected probe and tubing, a rotating ring lock locking the mixer base assembly to the bioprocess mixer system, a drive housing enclosing a mixer drive system, and supporting feet.

FIG. 1B shows an isometric frontal view of an embodiment of a support structure of a bioprocess mixer system described herien including an enclosure body supported above the drive housing.

FIG. 1C shows an isometric rear view of an embodiment of a support structure of a bioprocess mixer system including ports in the rear of the enclosure body.

FIG. 1D shows an isometric frontal view of an embodiments of a deconstructed support structure of a bioprocess mixer system including an enclosure body supported above a drive housing, the drive housing supporting on a base plate and comprising a load cell.

FIG. 1E shows a side view of an embodiment of a bioprocess mixer system with various internal components shown, including various ports and associated piping, the mixer drive system, and load cell.

FIG. 2A shows an isometric view of a bottom side of an embodiment of a mixer base assembly described herein showing a flat side wall.

FIG. 2B shows an isometric view of a bottom side of an embodiment of a mixer base assembly described herein showing a rounded side wall.

FIG. 2C shows a view of a top side of an embodiment of a mixer base assembly described herein.

FIG. 2D shows an isometric view of a top side of an embodiments of a mixer base assembly described herein.

FIG. 2E shows a view of a top side of an embodiment of a mixer base assembly described herein.

FIG. 2F shows a side view of a cross section of an embodiment of a mixer base assembly described herein.

FIG. 2G shows a side view of an embodiment of a mixer base assembly described herein.

FIG. 2H shows a view of a bottom side of an embodiment of a mixer base assembly described herein.

FIG. 2I shows a side view of a cross section of an embodiment of a mixer base assembly described herein, including an impeller, shaft, and shaft cap.

FIG. 2J shows a cross sectional view of an embodiment of an impeller, shaft, and shaft cap described herein.

FIG. 2K shows an isometric view of a bottom side of an embodiment of a mixer base assembly mated with an uninflated flexible bag mixing vessel.

FIG. 2L shows an isometric view of a top side of an embodiment of a mixer base assembly mated with an inflated flexible bag mixing vessel.

FIG. 3A shows a top view of an embodiment of a rotating ring lock positioned around a mixer base assembly in an unlocked position.

FIG. 3B shows a top view of an embodiment of a rotating ring lock positioned around a mixer base assembly in a locked position, with the rotating ring lock shown as transparent.

FIG. 3C shows a side view of an embodiment of a rotating ring lock positioned around a mixer base assembly, with the rotating ring lock shown as transparent.

FIG. 3D shows an isometric view of an embodiment of a bioprocess mixer system showing the position of the rotating ring lock positioned around a mixer base assembly in a locked position on the drive housing of the device.

FIG. 3E shows an additional isometric view of an embodiment of a bioprocess mixer system showing the position of the rotating ring lock positioned around a mixer base assembly in a locked position on the drive housing of the device.

FIG. 4A shows an isometric view of a bottom side of an embodiment of a jacketed mixing vessel housing described herein.

FIG. 4B shows an isometric view of an embodiment of a jacketed mixing vessel housing showing an interior space defined by the three jacketed walls into which a mixing vessel can be deposited.

FIG. 4C shows a cross sectional side view of an embodiment of a jacketed mixing vessel housing depicting the internal cavity and fluid flow path of the jacketed mixing vessel housing in operation.

FIG. 4D shows an isometric view of an embodiment of a jacketed mixing vessel housing with an exemplary dimple configuration.

FIG. 4E shows a side view of an embodiment of a jacketed mixing vessel housing with an exemplary dimple configuration.

FIG. 4F shows a cross sectional side view of an embodiment a bioprocess mixer system, with the support structure depicted as transparent and showing the location of the jacketed mixing vessel housing.

FIG. 5A shows a close-up view of an embodiment of a probe support holder described herein holding a probe.

FIG. 5B shows the opening motion of the probe support holder during insertion of the probe.

FIG. 5C shows a deconstructed view of the components of an embodiment of a probe support holder described herein.

FIG. 5D shows a cross sectional view of an embodiment of a probe support holder described herein comprising a mounting body and a retention latch (depicted as transparent).

FIG. 6A shows an embodiment of a drive housing of a bioprocess mixer system as described herein.

FIG. 6B shows an embodiment of a base plate of a bioprocess mixer system as described herein.

### DETAILED DESCRIPTION

Described herein in detail is a bioprocess mixer system and it associated components, including a mixer base assembly, locking mechanism (e.g., a rotating ring lock described herein), jacketed mixing vessel housing, and other features, which provide substantial advantages over the prior art. For example, the use a bioprocess mixer system as described herein and/or a mixer base assembly described herein allows a user to mix process fluids (in particular bioprocess fluids) at a wide range of volume at a wide range of temperatures within a single device. Additionally, further features described herein contribute to the ease of use of the system, including ease of assembly and operation in a manner which provides robust protection against process failure due to misalignment of the components and leakage and/or spills of process fluids. All these features are combined within one bioprocess mixer system with a small laboratory footprint (e.g., about 40 cm×40 cm with a height of about 60 cm or less).

In accordance with an embodiment of the instant disclosure, a bioprocess mixer system is provided, comprising: a mixer base assembly which comprises: (a) a body having: (i) an upper end including a mating face for mixing vessel connection; (ii) a lower end including a cavity; (iii) a plurality of side walls, the plurality of side walls comprising a rounded side wall and a flat side wall; (iv) an inlet port arranged in one of the one or more side walls; (v) an outlet port arranged in one of the one or more side walls; (vi) at least one probe port arranged in one of the one or more side walls; (vii) a fluid mixing chamber having a bottom wall; (b) an impeller seat arranged in the cavity in the lower end of the body; and (c) an impeller arranged in the impeller seat; and a mixer drive system comprising: (a) a drive system configured to drive the impeller; and (b) a housing containing the drive system, the housing comprising a locking mechanism configured to lock the mixer base assembly into an aligned position when connected to the housing.

In some embodiments, the locking mechanism is a rotating ring lock. In some embodiments, the rotating ring lock comprises a handle, a ring-portion conformed to the rounded side wall of the mixer base assembly, and a hook portion conformed to the flat side wall of the mixer base assembly. In some embodiments, the rotating ring lock is configured to rotate about the mixer base assembly between unlocked and locked positions. In some embodiments, the rotating ring lock is attached to the housing by a plurality of fasteners positioned through the ring-portion of the rotating ring lock, the plurality of fasteners configured to allow rotation of the rotating ring lock between locked and unlocked positions. In some embodiments, in the locked position, the rotating ring lock covers one or more protrusions from the rounded side wall and/or the flat side wall of the mixer base assembly, and wherein the one or more protrusions are not covered by the rotating ring lock in the unlocked position. In some embodiments, the rotating ring lock covers a first protrusion on the rounded side wall of the mixer base assembly and a second protrusion on the flat side wall of the mixer base assembly in the locked position.

In some embodiments, the bioprocess mixer system comprises a probe support holder configured to hold a probe in the probe port at a predetermined angle. In some embodiments, the probe support holder is mounted to an enclosure body configured to encase the mixing vessel positioned above the mixer drive system. In some embodiments, the probe support holder comprises a mounting body, a retention latch, and a torsion spring positioned to close the retention latch and hold the retention latch against the probe. In some embodiments, the mounting body and retention latch are two separate parts with the torsion spring positioned at an interface of the two parts. In some embodiments, the retention latch comprises a wedge structure configured to open the retention latch during insertion of the probe. In some embodiments, the probe support holder comprises a rounded portion to support the probe.

In some embodiments, the bioprocess mixer system comprises at least one probe insertable into the at least one probe port. In some embodiments, the probe measures at least one of pH, conductivity, temperature, or dissolved oxygen.

In accordance with an additional aspect of the instant disclosure. a jacketed mixing vessel housing ia provided, comprising: (a) three jacketed side walls, each of the three jacketed side walls connected to at least one of the other jacketed side walls, each of the jacketed side walls defining an interior cavity, wherein each of the interior cavities is in fluid connection with the others; (b) a base supporting the three jacketed side walls at a bottom side of the three jacketed side walls; (c) an inlet port on the bottom side of one of the jacketed side walls in fluid connection with the interior cavity; and (d) an outlet port on one of the jacketed side walls in fluid connection with the interior cavity at a top side of the interior cavity; wherein the bottom side of the jacketed wall side wall containing the inlet slopes downwardly in a direction towards the inlet port, and wherein the three interior cavities of the three jacketed side walls are configured such that the three interior cavities are substantially filled by a fluid entering the jacketed mixing vessel housing before the fluid reaches the outlet port.

In some embodiments, the three jacketed side walls are arranged in a U-configuration with an interior jacketed side wall connected to the other two jacketed side walls, and wherein the interior jacketed side wall comprises the outlet port, and wherein the other two jacketed side walls each comprises an inlet port. In some embodiments, the three jacketed side walls comprise a unitary panel which is wrapped to form the three jacketed side walls. In some embodiments, at least one of the three jacketed side walls comprises a plurality of dimples in the surface of the wall. In some embodiments, the three interior cavities of the three jacketed side walls form a single continuous interior cavity across the three jacketed side walls. In some embodiments, the three jacketed side walls further comprise an insulator. In some embodiments, the three jacketed side walls are arranged to at least partially enclose a mixing vessel.

In some embodiments, the base of the jacketed mixing vessel housing comprises a bottom jacket defining a bottom interior cavity, a bottom inlet port in fluid connection with the bottom interior cavity, and a bottom outlet port in fluid connection with the bottom interior cavity and the inlet port on the bottom side of one of the jacketed side walls. In some embodiments, the base comprises a corner bracket connecting the base to one of the jacketed side walls. In some embodiments, the jacketed mixing vessel housing further comprises a top plate attached to a top side of the three jacketed side walls, the top plate providing a surface which overhangs an exterior region defined by the three jacketed side walls.

In preferred embodiments, the inlet and outlet of the jacketed mixing vessel housing are in fluid connection with a fluid source configured to be heated and/or cooled by a heating/cooling unit. Many such heating/cooling sources are known in the art and include, for example, the Integral T 1200 Temperature Control Unit (TCU) manufactured by LAUDA.

In some embodiments, the jacketed mixing vessel housing is disposed within an enclosure body of a bioprocess mixer system further comprising a mixer drive system with i) a drive system; and ii) a drive housing containing the drive system and comprising a seat for a mixer base assembly comprising an impeller configured to be driven by the drive system. In some embodiments, the enclosure body is positioned above the mixer drive system. In some embodiments, the enclosure body further comprises an inlet port in fluid connection with the inlet port of the jacketed mixing vessel housing and an outlet port in fluid connection with the outlet port of the jacketed mixing vessel housing. In some embodiments, the enclosure body comprises a probe support holder as described herein.

In some embodiments, the bioprocess mixer system in which the jacketed mixing vessel housing resides further comprises a mixer base assembly as described herein. In some embodiments, the mixer base assembly comprises (a) a mixer base body having: (i) an upper end including a mating face for mixing vessel connection; (ii) a lower end including a cavity; (iii) one or more side walls; (iv) an inlet port arranged in one of the one or more side walls; (v) an outlet port arranged in one of the one or more side walls; (vi) at least one probe port arranged in one of the one or more side walls; and, (vii) a fluid mixing chamber having a bottom wall; (b) an impeller seat arranged in the cavity in the lower end of the body; and (c) the impeller arranged in the impeller seat.

In some preferred embodiments, a bioprocess mixer system described herein comprises a weighing system configured to weigh an amount of process fluid placed within the mixer base assembly and/or a mixing vessel disposed thereon.

In accordance with another aspect of the instant disclosure, a mixer base assembly is provided, comprising: (a) a body having: (i) an upper end including a mating face for mixing vessel connection; (ii) a lower end including a cavity; (iii) a fluid mixing chamber having a bottom wall; (iv) a rounded side wall and a flat side wall, wherein the rounded side wall at a first part is the only wall encasing the fluid mixing chamber and at a second part joins with the flat side wall to encase the fluid mixing chamber; (v) an inlet port arranged in one of the side walls; (vi) an outlet port arranged in one of the side walls, and; (vii) at least one probe port arranged in one of side walls; (b) an impeller seat arranged in the cavity in the lower end of the body; and, (c) an impeller arranged in the impeller seat. In some embodiments, the impeller is a levitating magnetic impeller comprising a magnet, a base, and at least two blades. In some embodiments, the mixer base assembly is present in the seat of the drive housing of the bioprocess mixer system.

In some embodiments, the mixer base assembly further comprises an alignment marker on one of the side walls configured to denote if the mixer base assembly is in a proper orientation for connection with the mixing vessel and/or a seat on a housing containing a drive system configured to drive the impeller. In some embodiments, the alignment marker is a protrusion or notch in one of the side walls. In some embodiments, the alignment marker is a protrusion on the flat side wall configured to interact with a rotating ring lock on the housing containing the drive system.

In some embodiments, the inlet port and/or the outlet port of the mixer base assembly is disposed on the rounded side wall. In some embodiments, the bottom wall of the mixing chamber slopes downwardly in a direction from the inlet port toward the outlet port. In some embodiments, the impeller is a levitating magnetic impeller comprising a magnet, a base, and at least two blades. In some embodiments, the levitating magnetic impeller comprises a central cavity, wherein the impeller seat comprises a shaft protruding through the central cavity of the levitating magnetic impeller, and a shaft cap configured to prevent the levitating magnetic impeller from becoming dislodged from the shaft. In some embodiments, the shaft cap has a greater diameter than the central cavity of the levitating magnetic impeller. In some embodiments, the levitating magnetic impeller is configured to rotate around the shaft. In some embodiments, the shaft cap is heat staked to the shaft.

In some embodiments, the probe port is positioned to position a probe into the fluid mixing chamber at a desired angle. In some embodiments, the mixer base assembly further comprises the least one probe inserted into the at least one probe port. In some embodiments, the probe measures at least one of pH, conductivity, temperature, or dissolved oxygen.

In some embodiments, the mixer base assembly is mated with the mixing vessel. In some embodiments, the mixing vessel is a flexible bag. In some embodiments, the flexible bag has a maximum working volume of at least 5 L. In some embodiments, the body is mated with the flexible bag. In some embodiments, the mixer base assembly has a hold up volume of less than 20 mL. In some embodiments, the inlet port and outlet port are mated in fluid connection with flexible tubing. In some embodiments, the flexible tubing mated in fluid connection with the outlet port comprises a tube junction comprising a sample port.

Also provided herein is a method for mixing fluid, the method comprising: 1) connecting a mixer base assembly to a mixer drive system, the mixer base assembly comprising (a) a body having: (i) an upper end including a mating face for mixing vessel connection; (ii) a lower end including a cavity; (iii) a plurality of side walls, the plurality of side walls comprising a rounded side wall and a flat side wall; (iv) an inlet port arranged in one of the one or more side walls; (v) an outlet port arranged in one of the one or more side walls; (vi) at least one probe port arranged in one of the one or more side walls; (vii) a fluid mixing chamber having a bottom wall; (b) an impeller seat arranged in the cavity in the lower end of the body; and (c) an impeller arranged in the impeller seat; and the mixer drive system comprising: (a) a drive system configured to drive the impeller; and (b) a housing containing the drive system, the housing comprising a locking mechanism configured to lock the mixer base assembly into an aligned position when connected to the housing; 2) introducing fluid into the fluid mixing chamber; and 3) rotating the impeller to mix the fluid in the fluid mixing chamber.

In some embodiments, the method comprises measuring the pH and/or conductivity of the fluid in the fluid mixing chamber. In some embodiments, the method comprises sampling the fluid in the fluid mixing chamber by removing a sample of the fluid by a sample port in fluid connection with the outlet port. In some embodiments, connecting the mixer base assembly to the mixer drive system comprises locking the mixer base assembly to the mixer drive system. In some embodiments, locking the mixer base assembly to the mixer drive system comprises rotating a rotating ring lock about the mixer base assembly. In some embodiments, the method comprises heating or cooling the fluid in the fluid mixing chamber. In some embodiments, the method comprises draining the fluid from the fluid mixing chamber via the outlet port, wherein the fluid mixing chamber has a hold-up volume of less than 30 mL. In some embodiments, the mixer base assembly is connected to the mixing vessel. In some embodiments, the mixing vessel is a flexible bag having a maximum working volume of at least 5 L. In some embodiments, the method comprises inserting a probe into a probe support holder mounted to an enclosure body configured to encase the mixing vessel positioned above the mixer drive system. In some embodiments, the method further comprises monitoring one or more parameter selected from impeller RPM, temperature, pH, and/or weight during the mixing. In some embodiments, the method further comprises recording one or more parameter selected from impeller RPM, temperature, pH, and/or weight during the mixing.

Advantageously, embodiments of the present disclosure can be used with a variety of mixing vessels having different shapes and/or configurations, though flexible bags are preferred. Among shapes of flexible bags used as mixing vessels, substantially cuboidal is preferred. Homogenized mixing of a wide range of liquid volumes (e.g, about 20 mL to about 10,000 mL) and/or a liquids having wide range of viscosities (e.g., about 1 to about 25 Centipoise (cP)) can be achieved. Embodiments of the invention are particularly advantageous for applications such as for mixing heavy powders, as vortexes are formed, which assist in efficient mixing. Moreover, the use of a levitating magnetic impeller significantly reduces shear force, and eliminates rubbing of parts, thus reducing or eliminating particle shed that could contaminate the fluid. Embodiments of the invention can be used with low volume mixing vessels, and if desired, can be connected to aseptic sampling devices (manual or automatic).

Preferably, a mixer base assembly described herein is single-use.

In some instances, the bioprocess mixer system according to the instant disclosure is capable of rapid mixing of components even at high viscosities. For example, in some embodiments, the bioprocess mixer system is capable of completely mixing 10 L of a process fluid of 25 centipoise (cP) within a time of less than about 60 seconds, less than about 30 seconds, less than about 20 second, or less than about 15 seconds (e.g., in a configuration wherein the mixing vessel mated to the mixer base assembly is a flexible bag having a working volume of 10 L). In some embodiments, the bioprocess mixer system is capable completely mixing any volume of process fluid from about 1 L to about 10 L with a viscosity of 1 to 25 cP within 300 seconds or less. Methods of measuring mixing completeness are known in the art and can include, for example, adding a bolus addition of strong acid or base to a fluid of known viscosity within the bioprocess mixer system, rotating the impeller, and assessing the amount of time taken to achieve a stable pH change from initial pH. Such tests are preferably performed at a mixing speed which is just below a vortex speed of the process fluid.

Additionally, a bioprocess mixer system according to the instant disclosure is preferably able to heat and/or cool a process fluid at a rapid rate (e.g., achieve a transition from room temperature (22° C.) to a temperature of about 40° C. or to a temperature of about 4° C. within 120 minutes for a 10 L sample of water).

Further details of a bioprocess mixer system and components thereof will now be described in more detail below, wherein like components have like reference numbers.

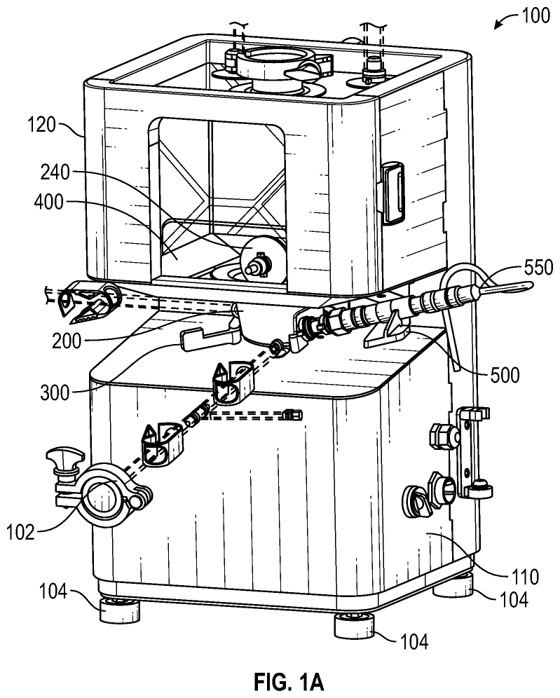

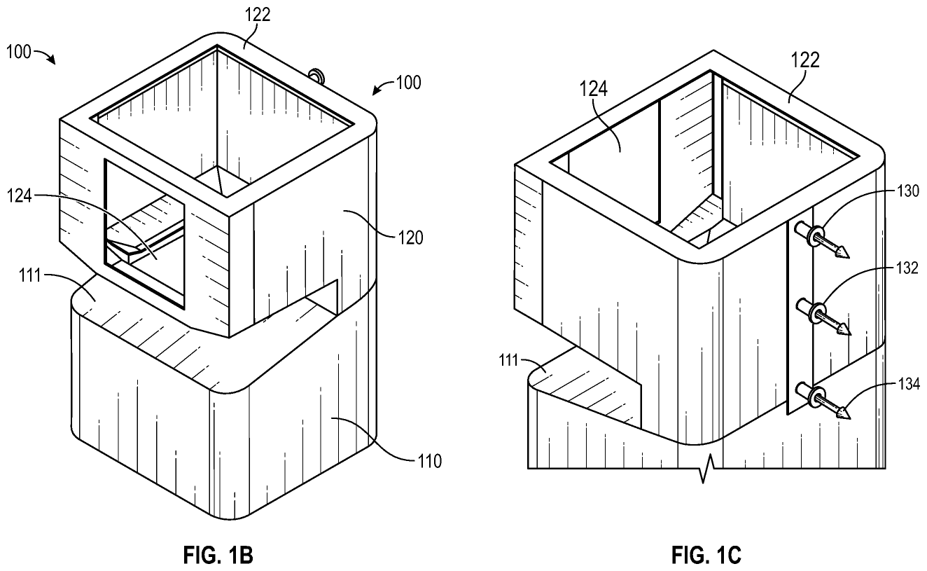

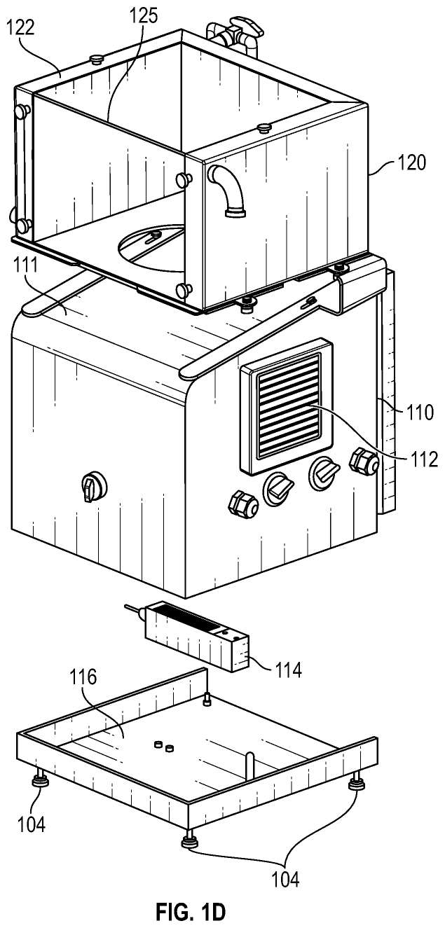

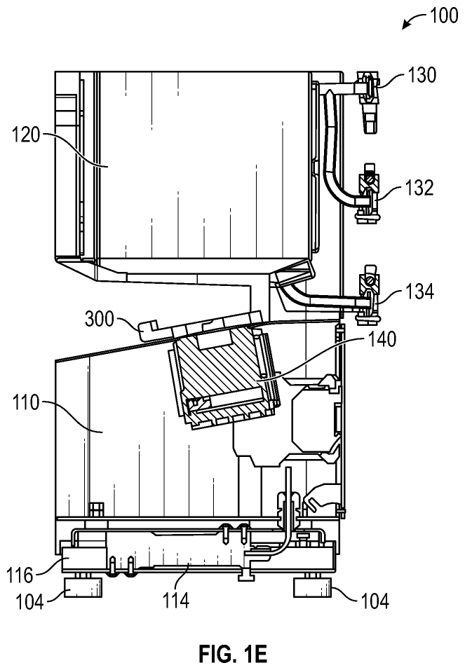

FIG. 1A shows a frontal view of a bioprocess mixer system 100 according to an embodiment described herein. The embodiment depicted includes an enclosure body 120 which contains or supports a jacketed mixing vessel housing 400. The jacketed mixing vessel housing 400 encloses on three sides a mixing vessel 240. The mixing vessel 240 is mated to a mixer base assembly 200. The mixer base assembly is configured with a probe 550 and tubing 102. The mixer base assembly 200 is inserted into a slot in drive housing 110 which contains a drive system configured to drive an impeller present within mixer base assembly 200. The mixer base assembly 200 is held into its position by a rotating ring lock 300. The probe 550 is held in place and supported at a desired or optimal angle by probe support holder 500 which is mounted to enclosure body 120. The bioprocess mixer system 100 rests on supporting feet 104.

Preferably, enclosure body 120 and drive housing 110 are made from a material with sufficient strength to support the weight of itself and the enclosed materials (e.g., stainless steel) and configured to withstand fatigue over the product life cycle.

FIG. 1B shows an embodiment of the structural components of the bioprocess mixer system 100 which hold and/or support the active functional components of the device of a bioprocess mixer system 100, in an isometric frontal view. The embodiment depicted includes enclosure body 120. Enclosure body 120 is configured to contain (i.e., at least partially surround) a mixing vessel during operation of the device. The enclosure body 120 includes access 124 positioned at the front of the device, which allows a user to easily reach within the enclosure body 120, such as for insertion or manipulation of a mixing vessel and/or mixer base assembly within the apparatus. Access 124 is depicted as an open window structure in FIG. 1B, but this can take the form of alternative structures, such as openable door or window, or the front wall of enclosure body 120 can be omitted entirely to allow ease of access to a user.

Preferably, the enclosure body 120 also contains a heating and/or cooling element (such as a jacketed mixing vessel housing as described elsewhere herein). The enclosure body 120 includes rest shelf 122 positioned its top which can be used to support the heating and/or cooling element during operation or during assembly. After placing the heating and/or cooling element on rest shelf 122, the element can be fixed into place, such as by welding or other suitable method.

The enclosure body 120 is supported above drive housing 110 which contains a drive system capable of driving an impeller on a mixer base assembly during operation. A mixer base assembly is placed within a position on upper face 111 of the drive housing 110 during operation in a position aligned with the drive system such that components are in proper orientation for proper functioning. Preferably, upper face 111 is sloped such that it matches a corresponding slope on a mixer base assembly 200 discussed elsewhere herein.

FIG. 1C shows a rear isometric view of an embodiment of bioprocess mixer 100, in which upper face 111 can be viewed along with access 124 and rest shelf 122. Also shown in FIG. 1C are ports 130, 132, and 134 which can be used to transport desired fluids to and/or from the bioprocess mixer 100. Ports 130, 132, and 134 can each independently be in fluid connection with corresponding ports on another part of bioprocess mixer system 100, such as a jacketed mixing vessel housing as described elsewhere herein. While shown with three ports 130, 132, and 134, the system can contain any desired number of ports (e.g., 0, 1, 2, 3, 4, 5, or more ports as desired). Additionally, rather than having its own ports and corresponding piping and/or tubing, enclosure body 120 can instead provide cavities which allow access to the ports of other components of bioprocess mixer system 100, such as the jacketed mixing vessel housing. Thus, the ports 130, 132, and/or 134 shown in FIG. 1C can be in fluid connection with other corresponding ports or can be coextensive with other suitable ports described herein.

FIG. 1D shows an isometric frontal view of an embodiments of a deconstructed support structure of a bioprocess mixer system 100 including an enclosure body 120 supported above a drive housing 110. The center of the enclosure body 120 is position directly above upper face 111 of the drive housing 100. Rest shelf 122 is shown at the top of enclosure body 120, upon which a jacketed mixing vessel as described elsewhere herein could be rested. Also depicted on enclosure body 120 is window 125 which allows a user to see a mixing vessel placed within enclosure body 120 during operation of the device. The window can be any suitable transparent or semi-transparent material which can allow line of sight into the central area defined by enclosure body 120. When present, window 125 is preferably configured to open and close to allow access to a mixing vessel enclosed therein.

The drive housing 110 is supported on a base plate 116 to which the supporting feet 104 are attached. The system also comprises a load cell 114 which is configured to measure weight contained in a mixing vessel used in the system, thus allowing a user to calculate volume delivered to a mixing vessel or drained from a mixing vessel during operation of the bioprocess mixer system 100. In some embodiments, an alternative weighing system can be used within a bioprocess mixer system 100, such as a scale or balance. The drive housing 110 can also contain one or more vents 112 to provide air flow to prevent overheating of any electronics or other components held within the drive housing 110. Preferably, the vents 112 can maintain the drive housing temperature below 65° C. for at least 8 hours of operation of the bioprocess mixer system.

FIG. 1E shows a side view of an embodiment of a bioprocess mixer system 100 with various internal components shown. For example, various ports 130, 132, and 134 and associated piping are shown as attached to further internal components contained within enclosure body 120 (e.g., a jacketed mixing vessel housing as described elsewhere herein). Also shown is mixer drive system 140 which is configured to drive an impeller when appropriately placed within rotating ring lock 300 on top of drive housing 110 (including an impeller such as a levitating magnetic impeller, such as those described herein in connection with mixer base assemblies provided herein). The drive system can be any suitable drive system and can include, for example, a motor, an input/output (TO) module, a power supply, fans, wiring and connections. A variety of motors for spinning (and, as appropriate, magnetically levitating) the impellers are known in the art. Commercially available motors include those available from Pall Corporation (Port Washington, N.Y.; e.g., LEVMIXER® SYSTEM) and Levitronix GmbH (Zurich, Switzerland). The drive system 140 is also favorably configured to run at different controllable impeller speeds which are capable of being monitored. The drive system 140 can also optionally contain a weighing system. Preferred embodiments such as depicted in FIG. 1E contain a load cell 114 for weighing materials on the bioprocess mixer system 100. The load cell 114 can be placed, for example and as shown, attached to base plate 116 and drive housing 100. The weighing system desirably has a high degree of measurement accuracy and precision, such as an error of less than 5% and more preferably and error of less than 0.1%.

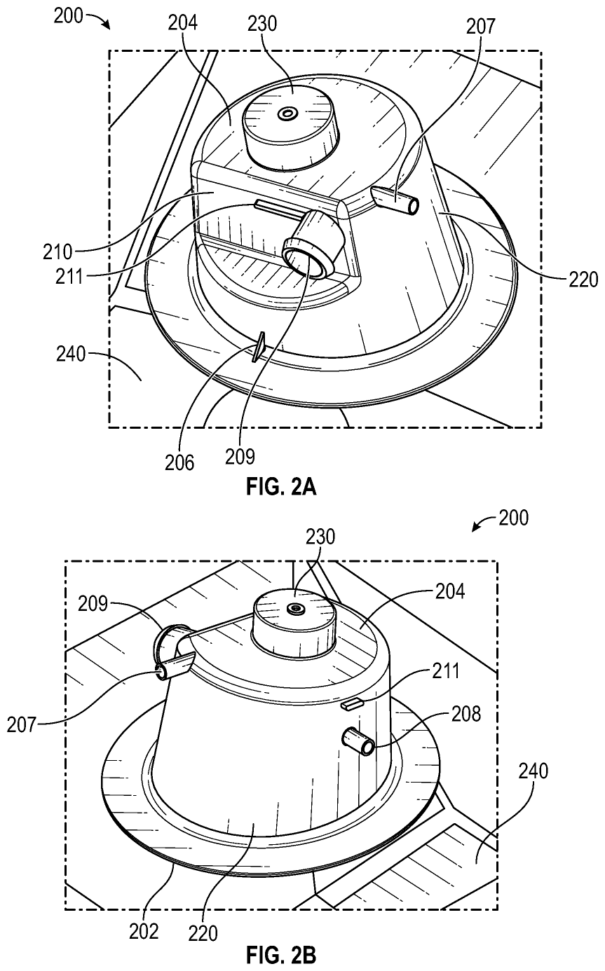

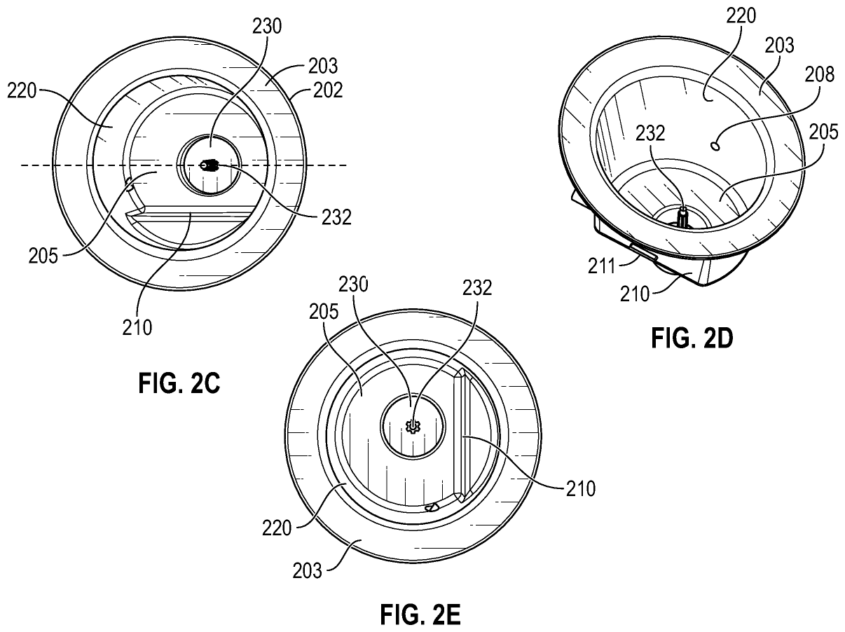

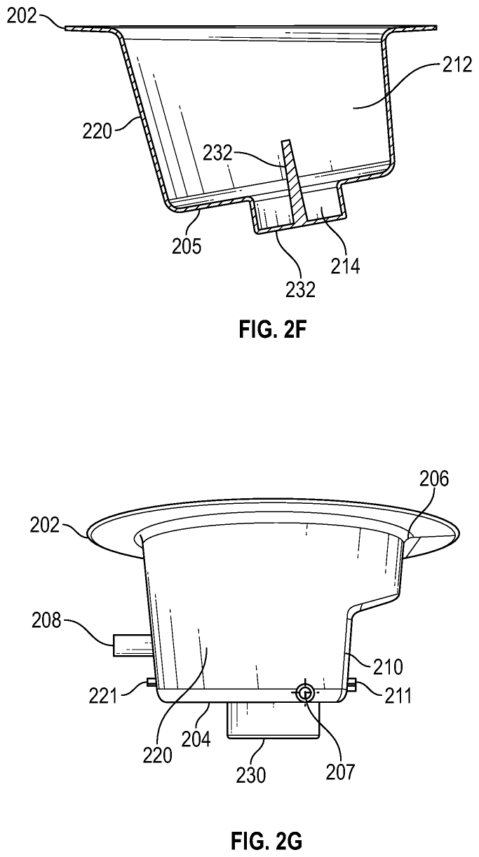

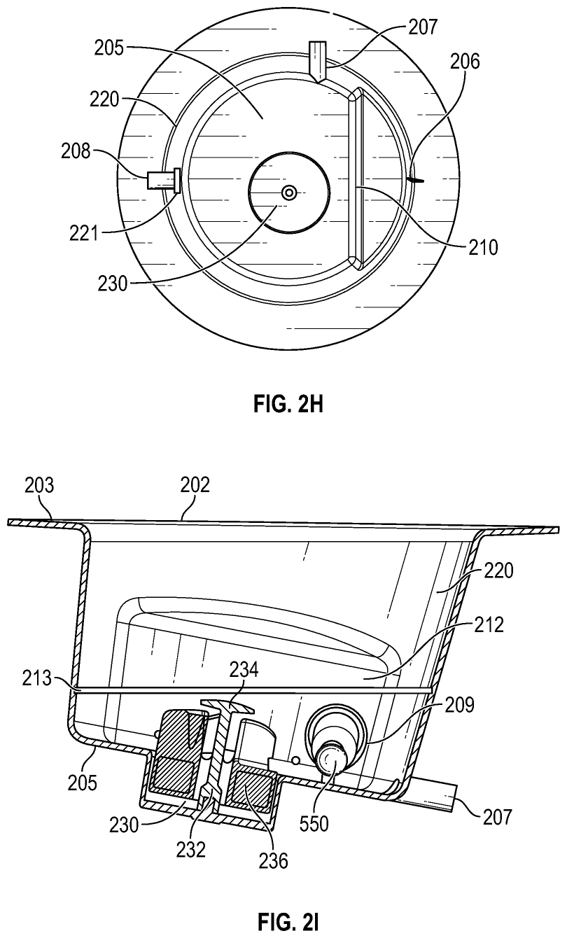

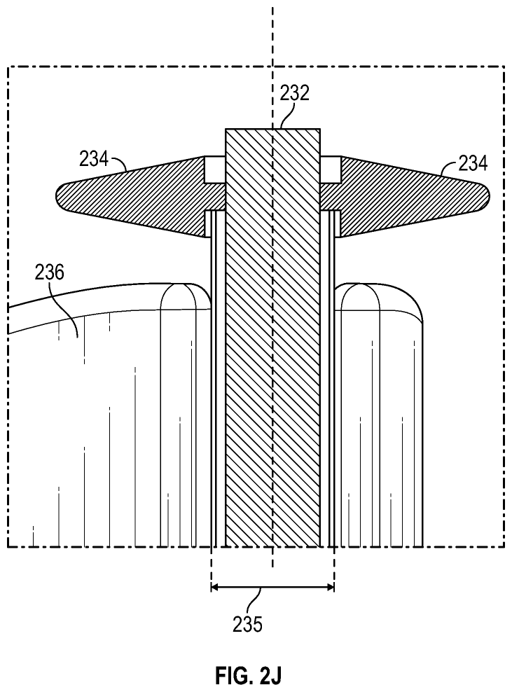

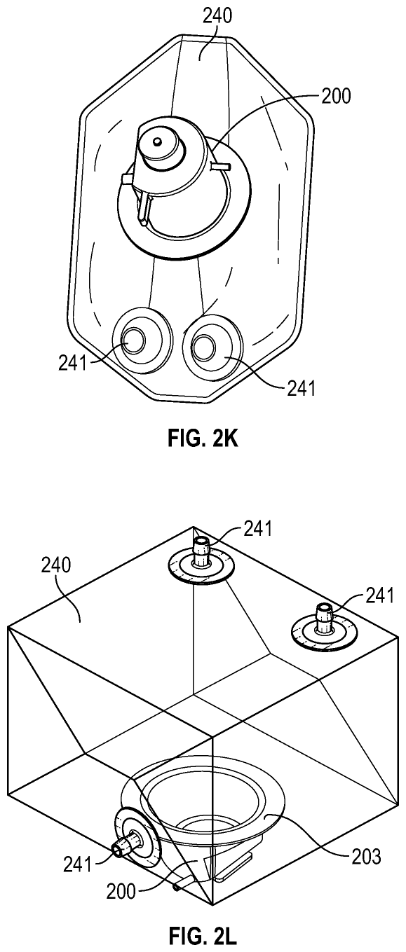

Turning to FIGS. 2A-2L, also provided herein is a mixer base assembly 200 which is compatible with a bioprocess mixer system 100 as described herein. As would be apparent to one of ordinary skill in the art, mixer base assembly 200 and/or features thereof described herein can also be compatible with alternative bioprocess mixer systems and are not limited to uses with bioprocess mixer system 100 provided herein, or with substantially analogous systems.

A mixer base assembly 200 described herein in certain embodiments contains (a) a body having: (i) an upper end 202 including a mating face 203 for connection to mixing vessel 240; (ii) a lower end 204 including a cavity 214; (iii) one or more side walls 210, 220; and (iv) a fluid mixing chamber 212 having a bottom wall 205. The mixer base assembly 200 optionally contains one or more ports selected from (i) an inlet port 208 arranged in one of the one or more side walls; (ii) an outlet port 207 arranged in one of the one or more side walls; and (iii) at least one probe port 209 arranged in one of the one or more side walls. The body can be fabricated from any suitable rigid impervious material, including any impervious thermoplastic material, which is compatible with the fluid being processed. The mixer base assembly 200 is preferably a single-use element designed to be discarded after use. Additionally, mixer base assembly 200 can preferably be pre-packaged in a sterilized form for use by the end user.

In some embodiments, the mixer base assembly comprises a rounded side wall 220 and a flat side wall 210. In some embodiments, the rounded side wall 220 at a first part (e.g., an upper portion) is the only wall encasing the fluid mixing chamber and at a second part (e.g., a lower portion) joins with the flat side wall 210 to encase the fluid mixing chamber. Thus, the fluid mixing chamber at certain elevations of the device (e.g., moving from a lower end 204 to an upper end 202) has a perimeter of different shapes, with the perimeter shape of the fluid mixing chamber 212 at the first part being circular or substantially circular and the perimeter shape at the second part being circular or substantially circular except for an omitted portion defined by a chord of the circle (i.e., where rounded side wall 220 meets flat side wall 210). In some embodiments, the inlet port and/or the outlet ports is disposed on the rounded side wall. In some embodiments, the bottom wall 205 of the mixing chamber 212 slopes downwardly in a direction from the inlet port 208 toward the outlet port 207. In some embodiments, the probe port 209 is positioned to position a probe 550 into the fluid mixing chamber 212 at a desired angle. In some embodiments, the mixer base assembly comprises at least one probe 550 insertable into the at least one probe port. In some embodiments, the probe measures at least one of pH, conductivity, temperature, or dissolved oxygen.

In some embodiments, the mixer base assembly further comprises an alignment marker 206 on one of the side walls configured to denote if the mixer base assembly is in a proper orientation for connection with the mixing vessel 240 and/or a seat 115 on a housing 110 containing a drive system configured to drive the impeller 236. In some embodiments, the alignment marker 206 is a protrusion or notch in one of the side walls. In some embodiments, the alignment marker is a protrusion 211 on the flat side wall 210 configured to interact with a rotating ring lock 300 on the housing 110 containing the drive system 140. In some embodiments, the alignment marker is a protrusion which denotes when the mixer base assembly is in proper orientation for alignment with a flexible bag mixing vessel, thereby assuring proper mating of the flexible bag.

The mixer base assembly 200 can also contain an impeller seat 230 arranged in the cavity 214 in the lower end of the body; preferably with an impeller 236 (e.g., a levitating magnetic impeller) arranged in the impeller seat 230. In some embodiments, the impeller 236 is a levitating magnetic impeller comprising a magnet, a base, and at least two blades. In some instances, use of a levitating magnetic impeller is preferred as it significantly reduces shear force and eliminates rubbing of parts, thus reducing or eliminating particle shed that could contaminate the fluid compared to other impellers. In some embodiments, the levitating magnetic impeller comprises a central cavity 235, wherein the impeller seat comprises a shaft 232 protruding through the central cavity of the levitating magnetic impeller, and a shaft cap 234 configured to prevent the levitating magnetic impeller from becoming dislodged from the shaft. In some embodiments, the shaft cap 234 has a greater diameter than the central cavity 235 of the levitating magnetic impeller. The levitating magnetic impeller is configured to rotate around the shaft 232. In some embodiments, the shaft cap 232 is heat staked to the shaft.

The mixer base assembly body preferably has a volume (e.g., a fluid mixing chamber volume) of about 200 to 800 mL, more preferably 300 mL to 700 mL, and most preferably 400 mL to 500 mL.

The features of the mixer base assembly 200 described herein allow for favorable mixing at both low working volumes and with low hold-up volume. In some embodiments, the mixer base assembly 200 has a minimum work volume of at most 100 mL, at most 75 mL, at most 50 mL, at most 45 mL, at most 40 mL, at most 35 mL, at most 30 mL, or at most 25 mL. In some embodiments, the mixer base assembly 200 has a hold-up volume of at most 50 mL, at most 45 mL, at most 40 mL, at most 35 mL, at most 30 mL, at most 25 mL, at most 20 mL, at most 15 mL, at most 10 mL, or at most 5 mL. As is apparent to one of ordinary skill in the art, the hold-up volume can depend on the viscosity of the process fluid within the vessel. Here, the mixer base assembly preferably has a hold-up volume of a 1 cP process fluid of less than 20 mL, and that such a hold-up volume can be achieved with minimal manipulation of the mixer base assembly and/or associated mixing vessel.

In some embodiments, the mixer base assembly 200 is mated with a mixing vessel 240. The mixing vessel can be any suitable mixing vessel compatible with the desired process fluid, but is preferably a flexible bag for bioprocess applications. In some embodiments, the mixing vessel has a maximum working volume of at least 0.5 L, at least 1 L, at least 2.5 L, at least 5 L, or at least 10 L.

Accordingly, the combination of the low minimum working volume of the mixer base assembly 200 described herein and the maximum working volume of the mixing vessel 240 compatible with said mixer base assembly 200 thus provides an bioprocess mixer system capable of working with a wide dynamic range of working volumes ranging from a few mLs (e.g., 25 mL) to 10 L, all within a single set-up.

FIG. 2A shows an isometric view of a lower end 204 of an embodiment of a mixer base assembly 200. Mixer base assembly 200 comprises a flat side wall 210 which comprises probe port 209. The probe port 209 is preferably configured to hold a probe 550 at a desired angle compatible with optimal probe functioning within the mixer base assembly 200. Also shown is flat side wall 210 optionally including a flat side wall protrusion 211. Flat side wall protrusion 211 is position such that it can interact with a rotating ring lock as described elsewhere herein. Mixer base assembly 200 also contains rounded side wall 220. Notably, rounded side wall 220 contains one portion which defines the entire perimeter of mixer base assembly 200 from upper end 202 until reaching the top of flat side wall 210, which traverses the remaining height of mixer base assembly 200 to lower end 204. Rounded side wall 220 and flat side wall 210 together define the perimeter of mixer base assembly for the remaining portion of mixer base assembly 200 (i.e., from the top of the flat side wall 210 to lower end 204). Flat side wall 210 and rounded side wall 220 thus both form edges with lower end 204 and with each other. Preferably, these edges are rounded, in particular on the interior of the device to minimize fluid retention around the edges and corners therein.

Also disposed on rounded side wall 220 is outlet port 207. Outlet port 207 is positioned on side wall 220 such that it is near or contacting lower end 204 to allow for maximum drainage of the device in operation. Desirably, probe port 209 is positioned on flat side wall 210 near or adjacent to outlet port 207 to allow an inserted probe to work with a minimum working volume. As will be shown in more detail in subsequent figures, the structure of mixer base assembly 200 contains a slope in a downward direction toward the outlet port 207 such that outlet port 207 is at substantially the lowest point of the device in operation in order to allow maximum drainage and minimize the amount of hold-up volume (also known as “carry-over volume” in the art) of the device.

Also depicted in FIG. 2A is alignment marker 206, which is a protrusion incorporated onto the exterior surface (here, rounded side wall 220 at the interface of the wall and upper end 202) of mixer base assembly 200. Alignment marker 206 provides a physical means on the device to ensure that mixer base assembly 200 is in proper orientation or alignment for connection with a mixing vessel 240 prior to attachment of the mixing vessel 240. In manufacturing, the presence of the alignment marker 206 can be aligned with a corresponding structural landmark on the mixing vessel 240 to ensure that the attachment is performed to the desired point and in the proper orientation for final use. While depicted as a protrusion in FIG. 2A, an alignment marker 206 could instead be a different feature on the device, such as a notch. Preferably, the mixer base assembly 200 is manufactured in a manner which ensures that alignment marker is always present at the desired location (e.g., using a mold). Additionally or alternatively, other elements of mixer base assembly 200 can also serve as alignment markers in a similar capacity, such as one of protrusions 211 and/or 221. Additional alignment markers 206 could also be incorporated, such as to denote if mixer base assembly 200 is in proper orientation for connection with a seat 115 on drive housing 110. Alternatively, alignment marker 206 as depicted could also serve this or another purpose as well.

Also depicted in FIG. 2A is impeller seat 230, which is disposed in the lower end 204 of the mixer base assembly 200. In operation, the lowest point of impeller seat 230 extends below the plane defined by lower end 204, but is preferably as shallow as possible in order to minimize hold up volume of fluid within the area occupied by the impeller 236. The diameter of impeller seat 230 is also favorably small for substantially identical reasons (i.e., the diameter of the impeller seat 230 only slight larger than that of impeller 236, such as at most 20%, at most 15%, at most 10%, or at most 5% larger). In some embodiments, impeller seat 230 is manufactured with the other components of mixer base assembly 200 (e.g., as a single, injection-molded part). Alternatively, it can be tightly sealed to the bottom wall of the fluid mixing chamber as a separate part.

As shown in FIG. 2A, the rounded side wall 220 at an upper portion of mixer base assembly 200 is the only wall encasing the fluid mixing chamber for that portion of the device. Additionally, at a lower portion of mixer base assembly 200, rounded side wall 220 joins with the flat side wall 210 to define the perimeter of the device. Thus, the fluid mixing chamber 212 disposed within the interior of the device at certain elevations of the mixer base assembly 200 (e.g., moving from a lower end 204 to an upper end 202) has a perimeter of different shapes, with the perimeter shape of a cross section of the fluid mixing chamber 212 at the first part being circular or substantially circular and the perimeter shape at the second part being circular or substantially circular except for an omitted portion defined by a chord of the circle (i.e., where rounded side wall 220 meets flat side wall 210). Use of such a shape within the device in some instances is beneficial for insertion of mixer base assembly 200 into a seat on drive housing 110 in the proper orientation for alignment with the drive system as the mixer base assembly 200 may only fit into the device in the proper orientation owing to the overall geometry of mixer base assembly 200.

FIG. 2B similarly shows an isometric view of lower end 204 of mixer base assembly 200 and showing a different portion of a rounded side wall 220 than that depicted in FIG. 2A. As in FIG. 2A, FIG. 2B also shows outlet port 207, probe port 209, impeller seat 230, and portions of upper end 202. The mixer base assembly 200 is also depicted as attached to mixing vessel 240. The mixing vessel 240 to which mixer base assembly 200 is attached is depicted as a flexible bag, but other mixing vessels (e.g., hard shell mixing vessels) are also contemplated as within the scope of the instant disclosure.

In addition to the features depicted in FIG. 2A, FIG. 2B further shows rounded wall protrusion 211 which also interacts with a rotating ring lock as described elsewhere herein. Also incorporated into rounded side wall 220 is inlet port 208 which can be used to fill the mixing vessel or add one or more of the desired components to be mixed.

FIG. 2C shows a top side view of mixer base assembly 200. FIG. 2C thus shows the interior space defined by the perimeter of flat side wall 210 and/or rounded side wall 220, as well as the interior faces of both of these walls, with upper end 202 being the nearest end of the device to the viewer. Shown on upper end 202 is mating face 203 to which a mixing vessel 240 as described herein can be mated. The mating can be by any suitable means, including via welding, adhesives, or other suitable methods. Preferably, mating face 203 is joined to the mixing vessel 240 via a weld, such as a weld with a flexible bag mixing vessel. Also shown is bottom wall 205 which defines the bottom of the interior portion, with the exception of impeller seat 230 also depicted and described. Within impeller seat 230 is shaft 232 around which impeller 236 (shown and described later herein) can freely rotate.

FIG. 2D shows an isometric view of a top side of mixer base assembly 200, shown from a direction including flat side wall 210 shown in the figure along with its corresponding protrusion 211. Like FIG. 2C, upper end 202 is nearest the viewer and mating face 203 can be seen. The interior surface of rounded side wall 220 is shown, with the cavity defined by inlet port 208 clearly shown. Bottom wall 205 and impeller shaft 232 are also shown.

FIG. 2E shows another top side view of mixer base assembly 200 from directly above. As in FIGS. 2C and 2D, bottom wall 205, impeller seat 230, impeller shaft 232, and mating face 203 can be seen. The interior surfaces of rounded side wall 220 and flat side wall 210 can also be seen. The walls are depicted as sloping slightly inward as they descend from upper end 202 to lower end 204.

FIG. 2F shows a side view of a cross section of an embodiment of a mixer base assembly 200. Upper end 202 is shown at the top of the figure and mixer base assembly 200 is being viewed from a view looking directly towards where flat side wall 210 would be present if depicted. Rounded side wall 220 is shown as defining the interior space which makes up fluid mixing chamber 212, the lower portion of which is defined by the plane of bottom wall 205. Impeller shaft 232 placed on impeller seat 230 is also shown, as is the cavity 214 in bottom wall 205 which will hold the impeller when present.

FIG. 2G shows a side view of mixer base assembly 200 viewing parallel to the plane defined by side wall 210, in which side wall protrusion 211 can be seen, and viewing directly into outlet port 207. Probe port 209 is omitted from the figure. Upper end 202 is shown at the top of the figure and lower end 204 positioned near the bottom. Rounded side wall 220 is shown and rounded side wall protrusion 221 can be seen, along with inlet port 208 and alignment marker 206. The exterior of impeller seat 230 is also shown.

FIG. 2H shows a view of a bottom side of mixer base assembly 200 in which the exterior of impeller seat 230 is positioned nearest the viewer above bottom wall 205 whose exterior is shown. Alignment marker 206 is shown connected to rounded side wall 220 along with rounded side wall protrusion 221 and inlet port 208 and outlet port 207. Probe port 209 is omitted. Flat side wall 210 is shown to the right of the figure.

FIG. 2I shows a side view of a cross section of mixer base assembly 200 with flat side wall 210 omitted from the image except for probe port 209 which contains a probe 550. FIG. 2I shows the details of fluid mixing chamber 212 including an impeller 236, impeller shaft 232, and shaft cap 234 within impeller seat 230. In operation, the impeller 236, which is preferably a levitating magnetic impeller, is capable of driving fluid mixing within fluid mixing chamber 212 as well as within mixing vessel 240 (not shown in FIG. 2I) which is mated with mating face 203 on upper end 202 through the hole in upper end 202 which allows for fluid connection between fluid mixing chamber 212 and mixing vessel 240.

The impeller is disposed on impeller seat 230 and comprises a magnet and at least two blades (e.g., 2, 3, 4, 5, or 6 blades). The blades preferably extend from the impeller seat 230 and into fluid mixing chamber 212.

Also clearly depicted in FIG. 2I is the orientation of outlet port 207 relative to the rest of the device and how the mixer base assembly 200 is preferably oriented in operation (e.g., when inserted into a bioprocess mixer system 100 as described herein). As discussed above, the mixer base assembly 200 is configured such that outlet port 207 occupies the lowest point of elevation along bottom wall 205, thereby allowing maximal draining of fluid from the vessel and contributing to minimal fluid loss after completion of operation. As shown, bottom wall 205 of the mixing chamber slopes downwardly in a direction toward the outlet port 207. This downward angle (as measured between the intersection of planes defined by mating face 203 and bottom wall 205) is selected to be sufficient to minimize fluid retention within the mixer base assembly upon draining of fluid via outlet port 207 (e.g., at least 1.2, 3, 4, or 5 degrees, and from about 5 to 20 degrees). In operation, upper end 202 is preferably oriented substantially parallel to the ground (or other surface upon which bioprocess mixer system 100 or other analogous system is placed) and with a bottom face of enclosure body 120 of a bioprocess mixer system 100. Also depicted in FIG. 2I is fill line 213 which indicates the minimum working volume of the mixer base assembly.

FIG. 2J shows an exploded cross sectional view of an impeller 236 (i.e., a levitating magnetic impeller) having a central cavity 235 having the indicated diameter, an impeller shaft 232, and shaft cap 234 attached to shaft 232. The impeller 236 is disposed around shaft 232, with the shaft protruding through the central cavity 235. The impeller 236 is configured to rotate around the shaft 232. The shaft 232 is taller than the blades of impeller 236 and has a smaller diameter than that of central cavity 235. Affixed to the top of shaft 232 is shaft cap 234 which is configured to prevent the levitating magnetic impeller from becoming dislodged from the shaft 232. In particular, a diameter of the shaft cap 234 (with diameter here referring to the maximum length across from tip to tip of the cap as the shaft cap 234 can be shapes other than circular) is greater than that of central cavity 235. Thus, when the impeller 236 is lifted during operation, it is prevented from leaving the shaft. In addition to preventing the impeller from being dislodged during operation, the shaft cap 234 also ensures that the impeller 236 remains positioned correctly during transport and shipping of a mixer base assembly 200. Such a consideration is of high importance in embodiments where the mixer base assembly 200 is pre-assembled and shipped to an end user in a sterile state, as manipulation of the mixer base assembly to re-position a dislodged impeller 236 could introduce contamination. The shaft cap 234 can be added to an existing shaft 232 by a variety of methods, but is preferably added by a heat-staking process, which allows for the shaft to be added at a late stage in manufacturing after the impeller has been inserted.

FIG. 2K shows a mixer base assembly 200 welded to mixing vessel 240, which in this instance is an uninflated flexible bag having ports 241. Such a configuration is advantageous for shipping and pre-sterilization of the components, which can then be used by an end user at a later date. FIG. 2L likewise shows a mixer base assembly 200 welded to mixing vessel 240 comprising ports 241. However, in FIG. 2L the flexible bag is inflated and mating face 203 can be seen welded to the mixing vessel 240. While the embodiments of mixer base assembly 200 described herein utilize a flat surface as the mating face 203, alternative embodiments with different faces for mixing vessel connection are contemplated, such as threading for a threaded connection with a suitable mixing vessel.

Additionally, the mixing vessel 240 shown as connected to mixer base assembly 200 herein is depicted as a flexible bag. However, other types of mixing vessels are compatible with the instant disclosure, such as rigid container mixing vessels (e.g., those made from thermoplastic materials), though flexible bags are preferred. The volume of the mixing vessel connected to mixer base assembly 200 can be many volumes, including those up to 10 L. In some embodiments, a mixing vessel connected to mixer base assembly 200 (e.g., a flexible bag) has a working volume of at least 0.5, at least 1, at least 2, at least 3, at least 4, at least 5, at least 7.5, or at least 10 L.

Additionally, while depicted herein with only three ports (outlet port 207, inlet port 208, and probe port 209), the use of additional ports to mixer base assembly 200 (e.g., a sample port) is compatible with the instant disclosure. Alternatively, a sample port can be added in fluid connection with one of the existing ports depicted on mixer base 200, preferably in fluid connection with the outlet port 207. For example, a sampling manifold (e.g., one comprising a sample port plug, sample port nut, and a sampling port) can be connected to outlet port 207 by appropriate tubing. Such a manifold is advantageously connected to such tubing by a junction (e.g., at T- or Y-connector) so as to allow sampling during operation while still allowing draining out of the same line upon completion of mixing. In some embodiments, the inlet port 208 and outlet port 207 are mated in fluid connection with flexible tubing 250. In some embodiments, the flexible tubing 250 mated in fluid connection with the outlet port 207 comprises a tube junction comprising a sample port.

Additionally, a mixer base assembly 200 which lacks one or more of the three ports illustrated is also contemplated as being within the scope of the instant disclosure. For example, in systems or configurations for processes where a probe is not necessary, probe port 209 can be omitted from the mixer base assembly, or the probe port 209 can simply be plugged with an appropriate plug. Additionally or alternatively, inlet port 207 could in some instance be omitted from the design for use in a process where it is appropriate to use the outlet port 208 to also pump in a desired process fluid.

In some embodiments, a bioprocess mixing system as described herein comprises a locking mechanism which is configured to lock a mixer base assembly into an aligned position (e.g., that an impeller is appropriately aligned with a drive system) when connected to the drive housing. This ensures that during operation of the device the mixer base assembly remains in the correct orientation for optimal performance and to ensure the mixer base assembly does not become dislodged, particularly in view of potential vibrations and other motion of the system due to movement of the drive system to drive the impeller of the device.

Accordingly, described herein is a rotating ring lock locking mechanism comprising a handle, a ring portion, and a hook portion. In some embodiments, the ring portion is conformed to the rounded side wall of a mixer base assembly described herein. In some embodiments, the hook portion is conformed to the flat side wall of the mixer base assembly. In some instances, the rotating ring lock is attached to housing of a bioprocess mixer described herein (e.g., a drive housing 110 of a bioprocess mixer system 100). Preferably, the rotating ring lock is attached by a plurality of fasteners positioned through ring-portion of the rotating ring lock. The plurality of fasteners are configured to allow rotation of the rotating ring lock between locked and unlocked positions. In some embodiments, in the locked position, the rotating ring lock covers one or more protrusions on one of the side walls of the mixer base assembly (e.g., a protrusion from the rounded side wall and/or the flat side wall of the mixer base assembly), and wherein the one or more protrusions are not covered by the rotating ring lock in the unlocked position.

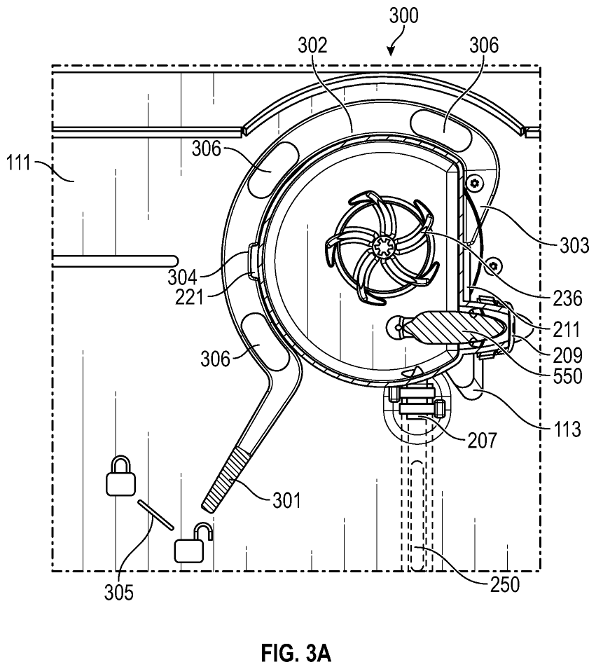

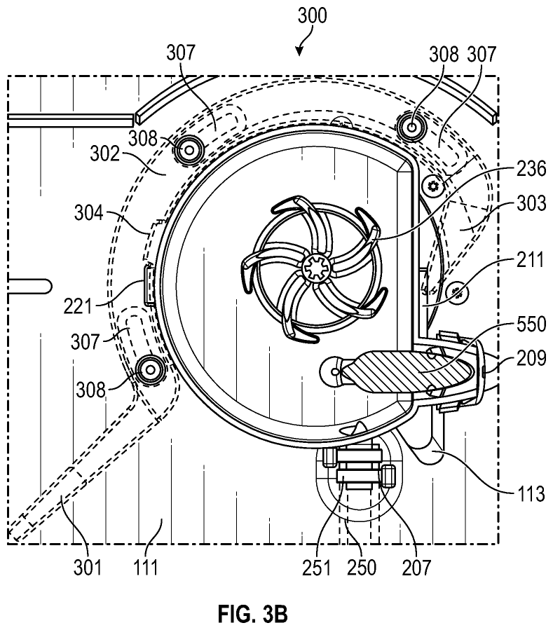

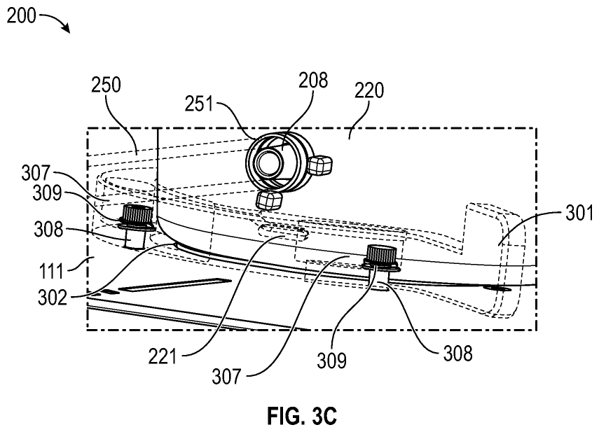

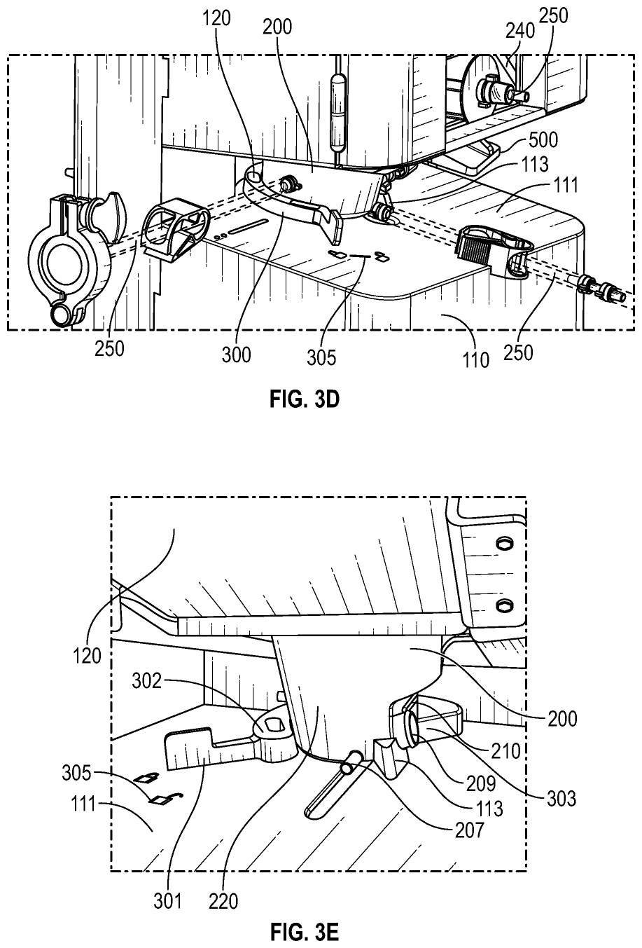

Turning to FIGS. 3A-3E, a rotating ring lock 300 is depicted which can be used to ensure a mixer base assembly, such as mixer base assembly 200, is effectively held and locked into place within a bioprocess mixer system such as bioprocess mixer system 100. The rotating ring lock 300 depicted therein comprises a handle 301, a ring portion 302 which conforms to the rounded side wall 220 of the mixer base assembly 200, and a hook portion 303.

FIG. 3A shows a top view of rotating ring lock 300 positioned around a mixer base assembly 200 in an unlocked position. This figure shows handle 301 connected to ring-portion 302 attached to hook portion 303. The ring portion 302 conforms to at least part of the rounded side wall 220 of the mixer base assembly 200. As reference points to mixer base assembly 200 discussed above, FIG. 3A shows probe port 209 with probe 550 inserted and outlet port 207 (with tubing 250 attached by cable ties 251 as denoted in FIG. 3B) of mixer base assembly 200, as well as impeller 236.

In some instances, the ring-portion 302 is substantially semi-circular (e.g., encompassing about 180 degrees of a circle), but other circumferential portions are contemplated and compatible with the instant disclosure (e.g., encompassing at least about or about 90 degrees, 120 degrees, 150 degrees, 180 degrees, or 210 degrees of a circle). The hook portion 303 and handle 301 are preferably placed at opposite ends of the ring-portion 302. The hook portion 303 is angled towards the interior of the round area defined by the ring-portion 302 at an angle which will allow the hook portion to contact or cover a portion of the mixer base assembly 200 in the locked position and thereby aid in preventing the mixer base assembly 200 from moving from the upper face 111 of drive housing 110 during operation. Preferably and as depicted, the hook portion 303 makes contact with a portion of flat side wall 210 of mixer base assembly 200. In FIG. 3A, the hook portion 303 is adjacent to but not covering flat side wall protrusion 211 in the unlocked position but will act to cover flat side wall protrusion 211 once moved to the locked position (FIG. 3B). The hook portion 303 can angle inwards at any suitable angle from the ring portion 301 (e.g., from about 30 degrees to about 120 degrees), but preferably conforms to the angle of the edge of rounded side wall 220 and flat side wall 210 of mixer base assembly 200.

The handle 301 is angled in an outward direction from the round area defined by the ring-portion 302. The angle selected is preferably approximately perpendicular to the ring-portion at the point at which the handle 301 begins on ring-portion 302, but other angles are contemplated as within the scope of the instant disclosure (e.g., any angle, such as from about 30 degrees to about 150 degrees, is allowable, so long as an operator is able to rotate rotating ring lock 300 using the handle 301). The handle 301, ring-portion 302, and hook 303 are preferably fabricated as a single-piece construction (e.g., manufactured from a single mold).

The rotating ring lock 300 is configured to rotate about the mixer base assembly 200 between unlocked and locked positions. Upper face 111 can include a position indicator 305 as shown in FIG. 3A which denotes whether the rotating ring lock 300 is in a locked or unlocked position. Upper face 111 also includes mixer base support 113 which provides additional support for mixer base assembly 200 when inserted into upper face 111. Mixer base support 113 can also be configured to ensure proper orientation of mixer base assembly 200 within the device.

The ring portion 302 also contains ring notch 304 as shown in FIG. 3A. Ring notch 304 is positioned to slot over rounded side wall protrusion 221 of mixer base assembly 200 in the open configuration (and during insertion into the bioprocess mixer system 100). Upon rotation of rotating ring lock 300 to the locked position, the ring notch 304 will also rotate, resulting in rounded side wall protrusion 221 becoming covered and/or contacted by ring portion 302 of the rotating ring lock 300, thus providing an additional (or, in certain embodiments, an alternative) point of contact with mixer base assembly 200 in order to effectuate the desired locking.

Further depicted on rotating ring lock 300 in FIG. 3A are caps 306 which cover slots 307 (as shown in FIG. 3B discussed below).

FIG. 3B shows a top view of rotating ring lock 300 positioned around a mixer base assembly 200 in a locked position in an exploded view relative to FIG. 3A. The rotating ring lock 300 and other components depicted in FIG. 3B are substantially identical to those of FIG. 3A, except handle 301, ring-portion 302, and hook portion 303 are depicted as transparent; caps 306 have been omitted to reveal slots 307 and fasteners 308; and rotating ring lock 300 is rotated relative to FIG. 3A to place it in a locked position. As can be seen, hook portion 303 now covers and/or contacts flat side wall protrusion 211 and ring notch 304 is no longer slotted over rounded side wall protrusion 221, thus preventing mixer base assembly 200 from becoming dislodged.

Ring portion 302 of rotating ring lock 300 is secured to upper face 111 by fasteners 308 through slots 307, which are configured to allow rotation of rotating ring lock 300. The fasteners 308 depicted in the figures are screws, though other alternative fasteners could also be used. Ring portion 302 is depicted as being attached via three sets of slots 307 and fasteners 308, though other numbers of sets of slots 307 and fasteners 308 are possible (e.g., 2, 3, 4, 5, or more sets).

The slots 307 are configured to allow a desired amount of rotation to rotating ring lock 300 in order to move between locked and unlocked positions. The degree of rotation can be any suitable degree which is allows for the change in covering and/or contact points of rotating ring lock 300 and mixer base assembly 200 (e.g., a rotation of from about 5 degrees to about 90 degrees, such as about 5, 10, 15, 20, 25, 30, 35, 40, 45, 50, 55, 60, 65, 70, 75, 80, 85, or 90 degrees), though preferably the degree of rotation allowed is relatively small (e.g., less than 60 degrees).

FIG. 3C shows a side view of rotating ring lock 300 positioned around mixer base assembly 200 in an unlocked position on upper face 111 with the handle 301 and ring portion 302 shown as transparent. Within slots 307 is shown how fasteners 308 (again depicted as screws, which are preferred fasteners) secure ring portion 302 to upper face 111, including use of washers 309 (e.g., triple wave washers). Also shown is the position of rounded side wall protrusion 221 and inlet port 208 of mixer base assembly 200 connected to tubing 250 by cable ties 251. As seen in FIG. 3C, rotating ring lock 300 contacts mixer base assembly 200 at a location below inlet port 208.

FIG. 3D shows an isometric view of a bioprocess mixer system showing the position of the rotating ring lock 300 positioned around a mixer base assembly 200 in a locked position on upper face 111 of the drive housing 110 of the device. Also further depicted in FIG. 3D are position indicator 305 and mixer base support 113 on upper face 111. Enclosure body 120 is also shown, with mixing vessel 240 shown deposited therein and with probe support holder 500 also shown thereon. Tubing 250 with various accessories (e.g., clamps, T-valves, Y-connectors, etc.) is also depicted as connected to various ports.

FIG. 3E shows an additional view of a bioprocess mixer system showing the position of the rotating ring lock 300 positioned around a mixer base assembly 200 in a locked position on upper face 111 of the drive housing 110 of the device and supported by mixer base support 113. Flat side wall 210 and probe port 209 are clearly visible, with hook portion 303 visibly contacting flat side wall 210. Ring portion 302 is also shown contacting rounded side wall 220, with outlet port 207 shown thereon. Handle 301 is depicted as pointed to the locked position on position indicator 305. Mixer base assembly 200 is also shown as contacting enclosure body 120 above it.

In some embodiments, a bioprocess mixing system as described herein comprises a jacketed mixing vessel housing which is configured to at least partially surround (e.g., surround in at least three directions) a mixing vessel. The jacketed mixing vessel housing comprises internal cavities which can be at least partially filled with a fluid which can be heated and/or cooled, preferably in a manner which allows the fluid to be recirculated (e.g., the jacketed mixing vessel housing contains suitable piping and connections with an external fluid heating/cooling source, such as a heating/cooling unit). This allows the fluid to regulate the temperature of a process fluid disposed within a mixing vessel in the interior of the jacketed mixing vessel housing.

Accordingly, provided herein is a jacketed mixing vessel housing comprising three jacketed side walls, each of the three jacketed side walls connected to at least one of the other jacketed side walls, and each of the jacketed side walls defining an interior cavity, and each of the interior cavities is in fluid connection with the others. The jacketed mixing vessel housing can further comprise a base supporting the three jacketed side walls at a bottom side of the three jacketed side walls. The jacketed mixing vessel housing can also comprise an inlet port on the bottom side of one of the jacketed side walls in fluid connection with the interior cavity and/or an outlet port on one of the jacketed side walls in fluid connection with the interior cavity at a top side of the interior cavity. In some instances, the bottom side of the jacketed side wall containing the inlet slopes downwardly in a direction towards the inlet port. In some embodiments, the three interior cavities of the three jacketed side walls are configured such that the three interior cavities are substantially filled by a fluid entering the jacketed mixing vessel housing before the fluid reaches the outlet port.

According to some embodiments, the three jacketed side walls are arranged in a U-configuration with an interior jacketed side wall connected to the other two jacketed side walls, and wherein the interior jacketed side wall comprises the outlet port, and wherein the other two jacketed side walls each comprises an inlet port. Additionally, in some instances, the three jacketed side walls comprise a unitary panel which is wrapped to form the three jacketed side walls. In some embodiments, the three interior cavities of the three jacketed side walls form a single continuous interior cavity across the three jacketed side walls. In some embodiments, at least one of the three jacketed side walls comprises a plurality of dimples in the surface of the wall. In some embodiments, the three jacketed side walls further comprise an insulator. In some embodiments, the three jacketed side walls are arranged to at least partially enclose a mixing vessel.

In some embodiments, the base of the jacketed mixing vessel housing comprises a bottom jacket defining a bottom interior cavity, a bottom inlet port in fluid connection with the bottom interior cavity, and a bottom outlet port in fluid connection with the bottom interior cavity and the inlet port on the bottom side of one of the jacketed side walls. In some instances, the base comprises a corner bracket connecting the base to one of the jacketed side walls. In some embodiments, the base is configured to support the mixing vessel when present within the jacketed mixing vessel housing. In some embodiments, the jacketed mixing vessel housing further comprises a top plate attached to a top side of the three jacketed side walls, the top plate providing a surface which overhangs an exterior region defined by the three jacketed side walls.

The jacketed mixing vessel housing described herein is favorably held within an enclosure body as described herein within a bioprocess mixer system.

A jacketed mixing vessel housing according to the instant disclosure is preferably coupled to a heating/and or cooling unit. Accordingly, in some instances, the inlet and outlet of the jacketed mixing vessel housing are in fluid connection with a fluid source configured to be heated and/or cooled by a heating/cooling unit. The fluid source used is preferably a mixture of ethylene glycol and water for optimal heating/cooling properties, such as a 1:1 mixture of ethylene glycol and water (v/v).

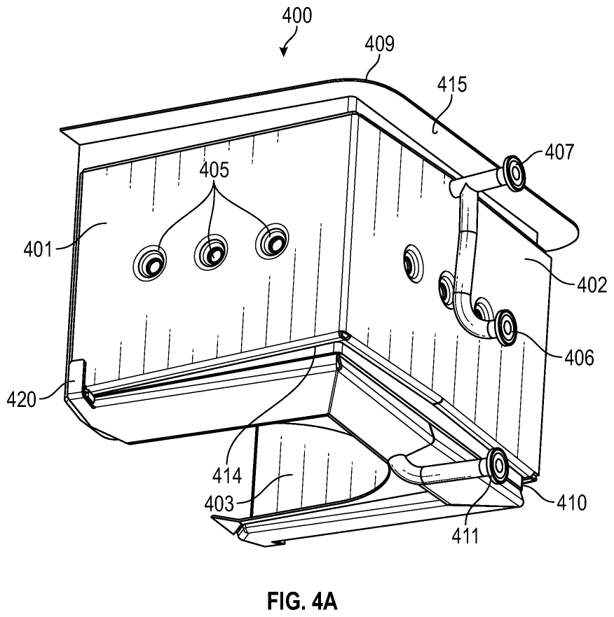

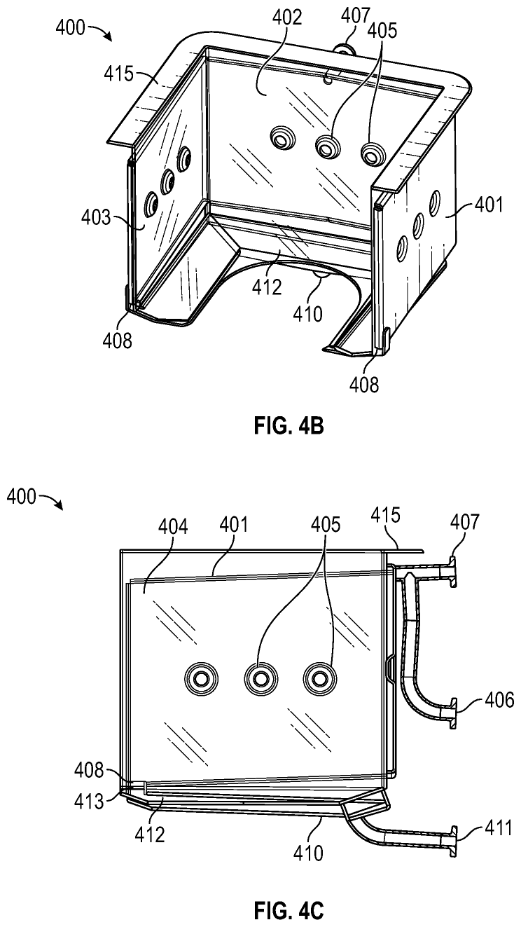

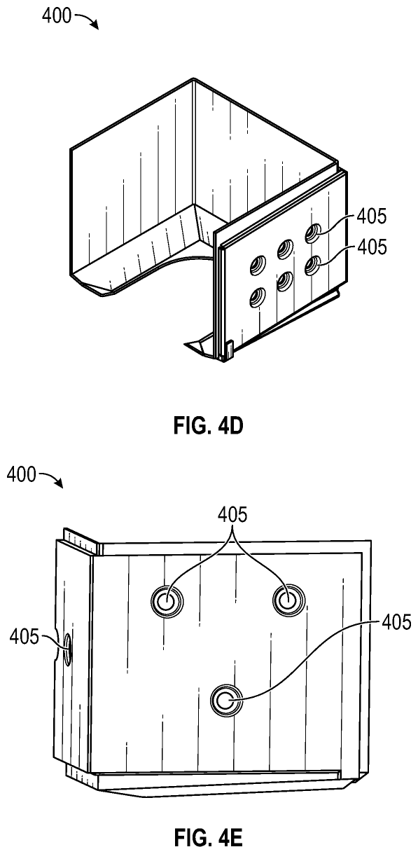

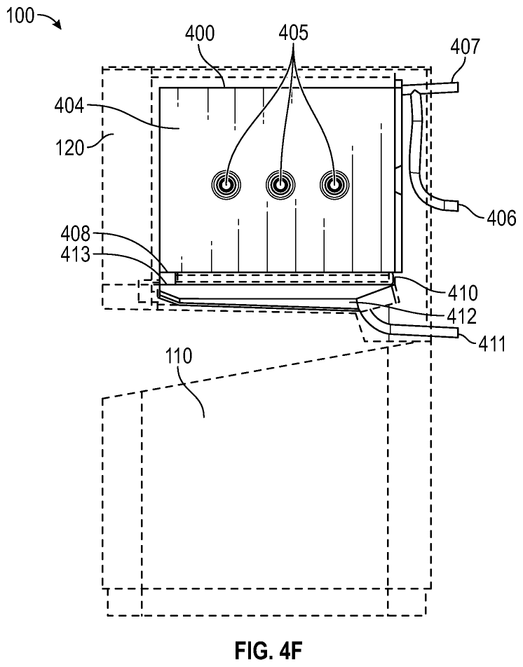

FIGS. 4A-4F herein describe an exemplary jacketed mixing vessel housing according to the instant disclosure. A jacketed mixing vessel housing 400 comprises a plurality of jacketed side walls (e.g., three jacketed side walls 401, 402, 403). Preferably, each of the jacketed side walls is connected to at least one of the other jacketed side walls. Each of the jacketed side walls defines an interior cavity 404, which is configured to receive a fluid which can preferably be heated and/or cooled (e.g., the fluid is configured to be recirculated with a heating/cooling unit). Preferably, each of the plurality of jacketed side walls is in fluid connection with the others, thus defining a single flow path through the jacketed mixing vessel housing. The plurality of walls of jacketed mixing vessel housing 400 can each be prepared as individual components but are preferably prepared from a single panel which is wrapped into the surrounding configuration. Thus, the “plurality of jacketed side walls” or a recitation of a specific number of jacketed side walls (e.g., three jacketed side walls) can refer to a single panel which is wrapped or folded into the surrounding configuration described herein. Additionally, the jacketed side walls can also further comprise an insulator in order to help retain heat during operation and potentially increase the rate at which process fluid in the mixing vessel heats during operation.

Preferably, at least one (and more preferably, at least two) of the jacketed side walls comprise an inlet port 408 on the bottom side 414 of the jacketed side wall in fluid connection with the interior cavity. At least one of the jacketed side walls (and preferably only one) comprises an outlet port 406 in fluid connection with the interior cavity 404 at or near a top side 409 of the jacketed side wall. This allows the heated and/or cooled fluid to traverse the jacketed mixing vessel housing in bottom-up flow path. Preferably, the plurality of jacketed side walls define a single internal cavity 404 without internal piping, thus allowing the internal cavity 404 to fill from the bottom up simultaneously rather than sequentially through individual jacketed side walls. The jacketed side walls are preferably sloped with inlet port 408 at the lowest point (e.g., a slope of about 2 degrees) to ensure proper filling of internal cavity 404 with heating/cooling fluid during operation. Additionally, placement of outlet port 406 in fluid communication at the top side 409 of the cavity allows all of the internal cavity 404 to become filled before the heating/cooling fluid leaves the jacketed mixing vessel housing 400. These features allow for uniform heating of process fluid within a mixing vessel which can be placed within the jacketed mixing vessel housing 400.

The jacketed mixing vessel housing can comprise a base 410 supporting the plurality jacketed side walls at a bottom side of the plurality jacketed side walls. The base 410 can also be jacketed with an interior cavity which is also in fluid communication with the interior cavities of the plurality of jacketed side walls. In such a configuration, the jacketed base 410 is configured to be first filled by a fluid which can be heated and/or cooled, at which point the fluid will exit the jacketed base 410 at at least one point and enter inlet port(s) 408 in the jacketed side wall(s) (preferably, into two separate jacketed side walls). Thus, this configuration allows for additional heating of a process fluid in a mixing vessel disposed within jacketed mixing vessel housing 400 from an additional side (the bottom side) while still allowing front access to the mixing vessel.

In a most preferred configuration of a jacketed mixing vessel housing 400 (as shown in, for example, FIG. 4B), a flow path of heating or cooling fluid flows through jacketed mixing vessel housing by first entering inlet port 411 of jacketed mixing vessel housing base 410 through bottom interior cavity 412 and wrapping around the bottom side 414 of the jacket side walls. The fluid then leaves jacketed base 410 and enters inlet ports 408 of two separate jacketed side walls 401 and 403 at a bottom side 414. The bottom side 414 slopes downwardly in a direction towards inlets 408 (e.g., about 2 degrees). The three interior cavities 404 (which effectively form a single continuous interior cavity across the three jacketed side walls 401, 402, and 403) are then uniformly filled across the bottom side as fluid continues to enter the inlets 408 until the fluid level reaches the outlet in fluid communication with the cavity 404 at the top side of middle jacketed side wall 402, thereby substantially filling each of the jacketed side walls 401, 402, and 403 with fluid for heating and/or cooling.

FIG. 4A shows an isometric view of a bottom side jacketed mixing vessel housing 400. Three jacketed side walls 401, 402, and 403 are depicted as substantially surrounding in three directions an interior space into which a mixing vessel can be placed. Jacketed mixing vessel housing 400 is depicted with a jacketed mixing vessel housing base 410 placed at the bottom sides 414 of jacketed side walls 401, 402, and 403. Jacketed mixing vessel housing base 410 is in this figure depicted as itself jacketed and comprising bottom inlet port 411 into which a fluid for heating and/or cooling can be delivered. The end of the flow path of a delivered fluid for heating and/or cooling through jacketed mixing vessel housing is shown in outlet 406 in fluid connection with a top side 409 of jacketed side wall 402. Also in fluid connection with outlet 406 is air purge 407, which ensures that any air trapped in the jacketed mixing vessel housing fluid flow path is able to be sparged during operation. The jacketed side walls are also pictured with dimples 405 in the side walls. In some embodiments, the presence of dimples 405 can result in enhanced heat transfer and/or uniformity of heat transfer to process fluid within a mixing vessel enclosed within the jacketed side walls 401, 402, and 403. The jacketed side walls 401 and 403 are mounted to the base at least through corner brackets 420 to provide additional support. The jacketed mixing vessel housing 400 also contains top plate with overhangs 415 which comprises overhangs oriented await from the interior space into which a mixing vessel can be placed. Top plate with overhangs 420 provide a contact surface through which the jacketed mixing vessel housing 400 can be placed into enclosure body 120 of a bioprocess mixer system 100 as described herein, such as by resting the overhangs on rest shelf 122. During operation, a mixing vessel can be rested on top of base 410.

FIG. 4B shows the same jacketed mixing vessel housing 400 with a view of an interior space defined by the three jacketed side walls 401, 402, and 403 into which a mixing vessel can be deposited. In this figure, the flow path of a fluid for heating and/or cooling of a mixing vessel is depicted, wherein the flow of the fluid beings in base 410 through cavity 412, which then exits base 410 and enters inlets 408 of jacketed side walls 401 and 403 to fill the cavity defined by the three jacketed side walls 401, 402, and 403. Dimples 405 can be seen on each of jacketed side walls 401, 402, and 403. Air purge 407 can also be seen in the rear of the jacketed mixing vessel housing 400.

FIG. 4C shows a cross sectional side view of jacketed mixing vessel housing 400 depicting the internal cavity 404 and fluid flow path of the jacketed mixing vessel housing 400 in operation. The cross section of jacketed side wall 401 is depicted revealing the internal structure of internal cavity 404, which contains no internal piping or other structure and is uninterrupted except for dimples 405. Such a configuration with no internal piping or other structure of the internal cavity 404 is preferred, though internal structure can be compatible with the instant disclosure (e.g., the addition of baffles or other structure to alter or guide the flow path through jacketed mixing vessel housing 400). To follow the flow path of a fluid for heating and/or cooling, the fluid enters at bottom inlet port 411 and traverses through bottom interior cavity 412 of base 410 until reaching bottom outlet port 413 of base 410. The fluid then enters inlet port 408 of jacketed side wall 401 (and, simultaneously, inlet port 408 at a corresponding position of jacketed side wall 403 not shown in the image). Each of jacketed side walls 401, 402, and 403 then become filled with the fluid from the bottom up, aided by the downward slope of the bottom of jacketed side walls 401, 402, and 403 towards inlet ports 408. The downward slope can have any desired angle, but is preferably a gentle angle of less than 10 degrees, more preferably less than 5 degrees, and most preferably about 2 degrees or less. Upon filling interior cavity 404, the fluid travels out of the device at outlet 406 in fluid communication with the top of interior cavity 404, with any trapped air allowed to escape via air purge 407. Top plate with overhangs 415 is also shown.

FIG. 4D shows an isometric view a jacketed mixing vessel housing 400 with an alternative configuration of dimples 405. FIG. 4E likewise shows a side view of a jacketed mixing vessel housing 400 with another configuration of dimples 405. Any configuration of dimples 405 is compatible with the instant disclosure, and indeed each jacketed side wall of the device can have a different dimple configuration.

FIG. 4F shows a cross sectional side view of bioprocess mixer system 100, with features and connections of jacketed mixing vessel 400 thereto emphasized. Enclosure body 120 is depicted as transparent and showing the location of jacketed mixing vessel housing 400 disposed therein placed above drive housing 110. All the features of FIG. 4C of jacketed mixing vessel housing 400 are shown, including base 410, bottom inlet port 411, bottom interior cavity 412, bottom outlet port 413 with connection to inlet port 408, outlet 406 in fluid communication with the top of interior cavity 404, air purge 407, and dimples 405.

As shown in FIG. 4F, bottom inlet port 411, outlet port 406, and air purge 407 are depicted as part of jacketed mixing vessel 400 and extending through enclosure body 120. In an alternative embodiment, jacketed mixing vessel housing 400 can instead have an outlet port 406 in fluid connection with an additional port and corresponding piping present on the enclosure body 120 (e.g., with port 132 depicted in FIG. 1C) and/or bottom inlet port 411 can be in fluid connection with an additional port and corresponding piping present on the enclosure body 120 (e.g., with port 134 depicted in FIG. 1C). In such embodiments, the outlet port 406 and/or the bottom inlet port 411 would refer to the portion of the jacketed mixing vessel housing 400 which contacts and is mated with the corresponding piping of enclosure body 120.

In some embodiments, a bioprocess mixing system as described herein comprises a probe support holder. A probe support holder as described herein is able to hold and support a probe during operation of the device. Preferably, the probe support holder is able and configured to hold a probe within a probe port at a predetermined and/or desired angle. Such a property is desirable when used in conjunction with certain probes that must be operated at a specific angle for proper functioning and where the shape and/or structure of a mixer base assembly makes it difficult to support such a probe by itself and retain the probe in the desired configuration. A probe support holder as provided herein can favorably be mounted to a bioprocess mixing system as described herein, such as to an enclosure body described herein.

In some embodiments, a probe support holder described herein can comprise a mounting body, a retention latch, and a torsion spring. The torsion spring is positioned and/or configured to close the retention latch and thereby hold the retention latch against a probe. The mounting body and retention latch can be two separate parts with the torsion spring position an interface of the two parts. The retention latch can also favorably comprise a wedge structure configured to open the retention latch during insertion of the probe into the probe support holder. The probe support holder also favorably comprises a surface which conforms to the shape of the probe, such as a rounded portion to support a rounded probe. The probe which can be mounted using the probe support holder can be any desirable probe, including without limitation probes to measure at least one of pH, conductivity, dissolved oxygen (or other gas), or any other salient feature of a process fluid.

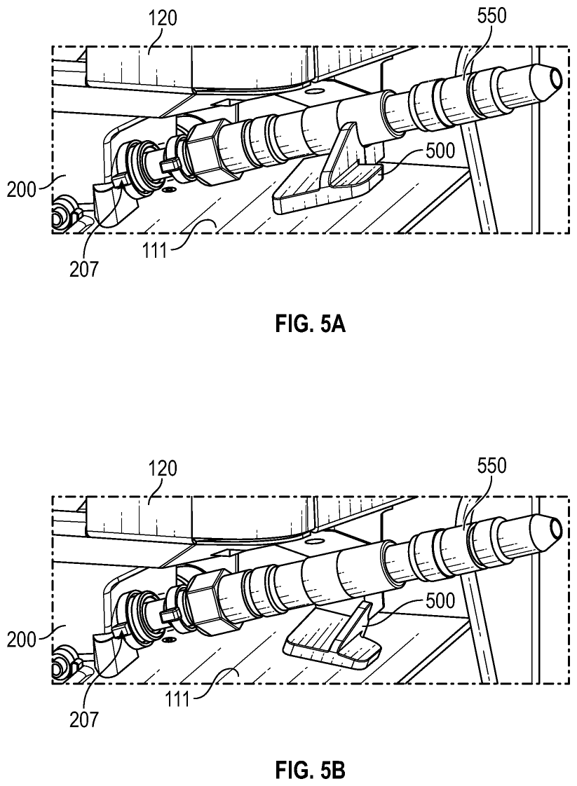

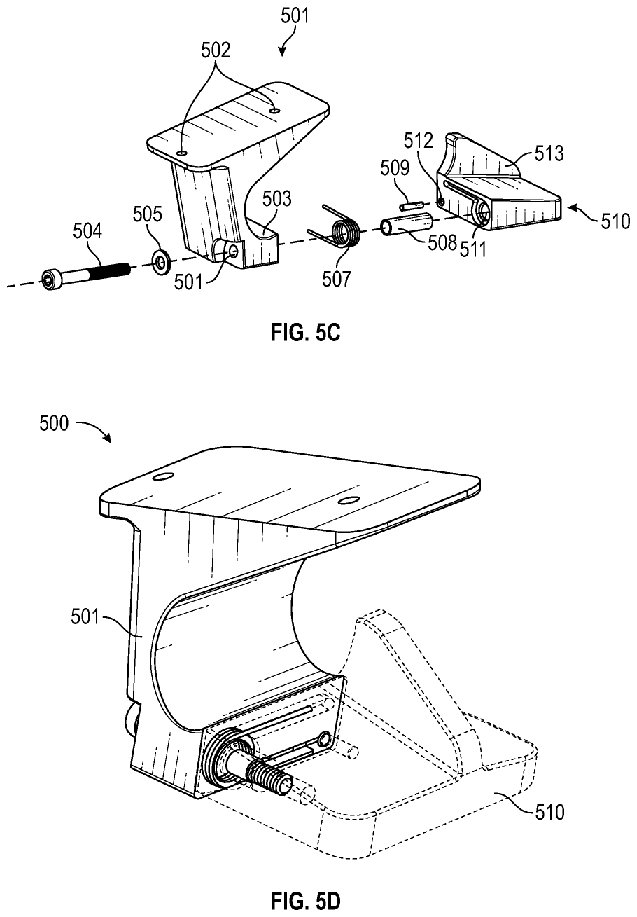

Turning to FIGS. 5A-5D, also provided herein is probe support holder 500 which is compatible with a bioprocess mixer system 100 as described herein. As would be apparent to one of ordinary skill in the art, probe support holder 500 described herein can also be compatible alternative bioprocess mixer systems and are not limited to uses with bioprocess mixer system 100 provided herein, or with substantially analogous systems.

FIG. 5A shows a close-up view of probe support holder 500 described herein. Probe support holder 500 is depicted as mounted to an enclosure body 120 above upper face 111 of a bioprocess mixer system described herein. Probe support holder 500 is shown holding probe 550 in place within probe port 207 on mixer base assembly 200. The probe support holder 500 is shown in a closed latch position.

FIG. 5B shows a close-up view of the same probe support holder 500 shown in FIG. 5A in an open latch position and with the opening motion denoted. As shown, probe support holder 500 comprises a portion (retention latch 510 shown in FIGS. 5C and 5D) which is configured to move downward during insertion of the probe 550 into the holding position of probe support holder 500.

FIG. 5C shows an exploded view of the components of probe support holder 500 described herein. Specifically, probe support holder 500 comprises two parts which make up the exteriors of the device. These two parts include mounting body 501 which is capable of being mounted to a desired surface (e.g., enclosure body 120) through mounting holes 502, which can be used in conjunction with suitable fasteners (e.g., screws) to mount probe support holder 500 to the desired surface. The second exterior part of probe support holder 500 is retention latch 510. Retention latch 510 includes an insertion wedge 513 which acts to drive retention latch in a downward direction during insertion of a probe 550 into probe support holder 500 when probe 500 moves into probe support surface 503 in a lateral direction across the device. Probe support surface 503 is conformed to the shape of the desired probe and preferably comprises a rounded portion in order to be compatible with most commercially available probes. Upon moving of probe 550 past insertion wedge 513 during insertion, torsion spring 507 acts to snap retention latch 510 back into the closed position, thereby securing the probe 550 in place.

FIG. 5C also depicts the hardware and other features which are used to assemble the device and includes screw 504, washer 505, torsion spring 507, sleeve bushing 508, and dowel 509 inserted into the relevant holes of the device. Specifically, screw 504 traverses through hole 506 in the mounting body 501, torsion spring 507, and sleeve bushing 508 before finally entering receiving hole 511 on retention latch 510. Dowel 509 is inserted into separate holes on the two parts. Importantly, torsion spring 507 is positioned at the interface of mounting body 501 and retention latch 510 such that when compressed, it will drive back the two components into the closed position and thereby secure probe 550 in place. FIG. 5D shows a cross sectional view of probe support holder 500 as fully assembled with mounting body 501 depicted as connected to retention latch 510 (depicted as transparent). The other associated hardware can be seen therein.

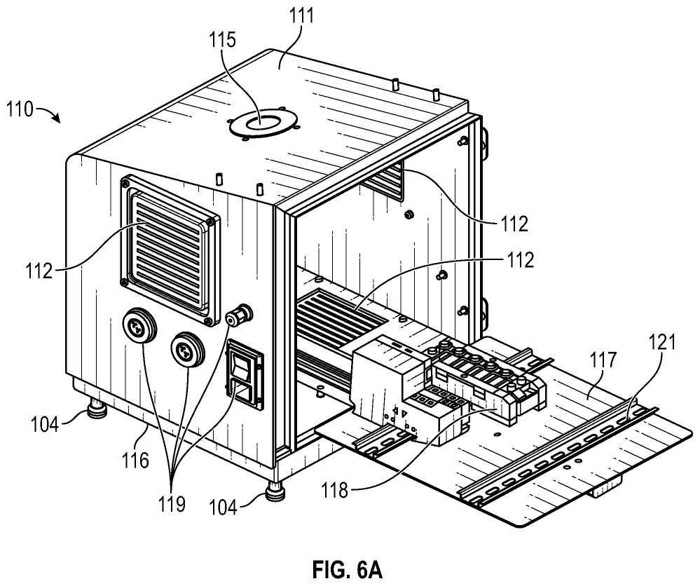

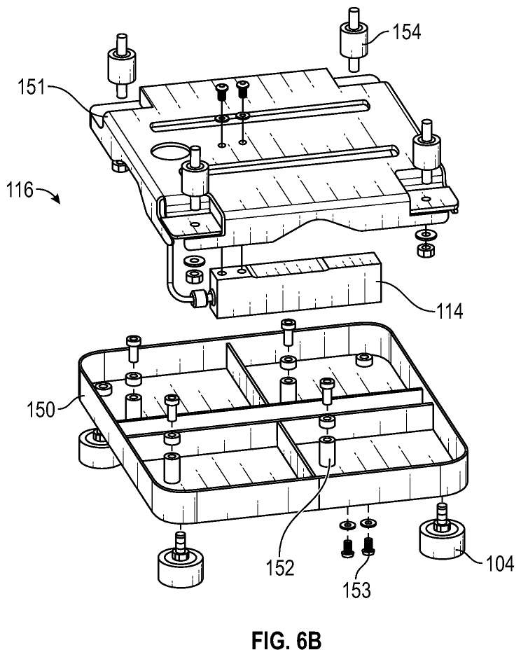

Turning to FIG. 6A, further details of an embodiment of drive housing 110 and associated features are shown. Drive housing 110 comprises a mixer base seat 115 on upper face 111 which is configured to receive a mixer base assembly (e.g., mixer base assembly 200 described herein) and orient the mixer base assembly in a proper orientation for operation. Drive housing 110 also comprises vents 112 to allow air flow into drive housing 110 to reduce the risk of overheating of the various components placed therein, including drive system and/or other electronics 118. The drive housing 110 preferably contains an access door 117 which can be opened in order to allow access to the electronics 118 and other materials stored inside. The access door 117 can also contain brackets 121 on which electronics 118 can be mounted. The exterior of the drive housing 110 also contains electrical ports 119 from which power can be supplied to various components of the device (e.g., the drive system, probes, etc.). Drive housing 110 can be mounted on base plate 116 with support feet 104 contacting the surface on which the device is rested. Support feet 104 are optimally adjustable to allow appropriate balancing of the devise.

FIG. 6B shows additional details of base plate 116 and its components. Base plate 116 comprises top plate 151 and welded base 150 which are connected by suitable fasteners which preferably include vibration damping isolators 154. Load cell 114 is positioned between welded base 150 and top plate 151 and is held in place by load cell mounting screws 153. The load cell 114 is configured to be able to accurately weigh contents placed into mixer base assembly 200 and a corresponding mixing vessel in operation.

All publications, patents, and patent applications mentioned in this specification are herein incorporated by reference to the same extent as if each individual publication, patent, or patent application was specifically and individually indicated to be incorporated by reference.

Unless defined otherwise, all technical and scientific terms and any acronyms used herein have the same meanings as commonly understood by one of ordinary skill in the art in the field of the invention. Although any methods and materials similar or equivalent to those described herein can be used in the practice of the present invention, the exemplary methods, devices, and materials are described herein.

### Definitions

As used herein, the terms “comprises,” “comprising,” “includes,” “including,” “has,” “having,” “contains”, “containing,” “characterized by,” or any other variation thereof, are intended to encompass a non-exclusive inclusion, subject to any limitation explicitly indicated otherwise, of the recited components. For example, subject matter that “comprises” a list of elements (e.g., components, features, or steps) is not necessarily limited to only those elements (or components or steps), but may include other elements (or components or steps) not expressly listed or inherent to the subject matter.

As used herein, the transitional phrases “consists of” and “consisting of” exclude any element, step, or component not specified. For example, “consists of” or “consisting of” used in a claim would limit the claim to the components, materials or steps specifically recited in the claim. When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a subject matter that includes materials, steps, features, components, or elements, in addition to those literally disclosed, provided that these additional materials, steps, features, components, or elements do not materially affect the basic and novel characteristic(s) of the claimed subject matter. The term “consisting essentially of” occupies a middle ground between “comprising” and “consisting of”.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

The term “and/or” when used in a list of two or more items, means that any one of the listed items can be employed by itself or in combination with any one or more of the listed items. For example, the expression “A and/or B” is intended to mean either or both of A and B, i.e. A alone, B alone or A and B in combination. The expression “A, B and/or C” is intended to mean A alone, B alone, C alone, A and B in combination, A and C in combination, B and C in combination or A, B, and C in combination.

It is understood that aspects and embodiments of the disclosure described herein include “consisting” and/or “consisting essentially of” aspects and embodiments.

It should be understood that any description in range format is merely for convenience and brevity and should not be construed as an inflexible limitation on the scope of the claimed invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range. Values or ranges may be also be expressed herein as “about,” from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In embodiments, “about” can be used to mean, for example, within 10% of the recited value, within 5% of the recited value, or within 2% of the recited value.

What is claimed is:

1. A jacketed mixing vessel housing, comprising:
(a) three jacketed side walls, each of the three jacketed side walls connected to at least one of the other jacketed side walls, each of the jacketed side walls defining an interior cavity, wherein each of the interior cavities is in fluid connection with the others;
(b) a base supporting the three jacketed side walls at a bottom side of the three jacketed side walls;
(c) an inlet port on the bottom side of one of the jacketed side walls in fluid connection with the interior cavity; and
(d) an outlet port on one of the jacketed side walls in fluid connection with the interior cavity at a top side of the interior cavity;
wherein the bottom side of the jacketed wall side wall containing the inlet slopes downwardly in a direction towards the inlet port, and
wherein the three interior cavities of the three jacketed side walls are configured such that the three interior cavities are substantially filled by a fluid entering the jacketed mixing vessel housing before the fluid reaches the outlet port.

2. The jacketed mixing vessel housing of claim 1, wherein the three jacketed side walls are arranged in a U-configuration with an interior jacketed side wall connected to the other two jacketed side walls, and wherein the interior jacketed side wall comprises the outlet port, and wherein the other two jacketed side walls each comprises an inlet port.

3. The jacketed mixing vessel housing of claim 1, wherein the three jacketed side walls comprise a unitary panel which is wrapped to form the three jacketed side walls.

4. The jacketed mixing vessel housing of claim 1, wherein at least one of the three jacketed side walls comprises a plurality of dimples in the surface of the wall.

5. The jacketed mixing vessel housing of claim 1, wherein the base comprises a bottom jacket defining a bottom interior cavity, a bottom inlet port in fluid connection with the bottom interior cavity, and a bottom outlet port in fluid connection with the bottom interior cavity and the inlet port on the bottom side of one of the jacketed side walls.

6. The jacketed mixing vessel housing of claim 1, wherein the base comprises a corner bracket connecting the base to one of the jacketed side walls.

7. The jacketed mixing vessel housing of claim 1, further comprising a top plate attached to a top side of the three jacketed side walls, the top plate providing a surface which overhangs an exterior region defined by the three jacketed side walls.

8. The jacketed mixing vessel housing of claim 1, wherein the three interior cavities of the three jacketed side walls form a single continuous interior cavity across the three jacketed side walls.

9. The jacketed mixing vessel housing of claim 1, wherein the three jacketed side walls further comprise an insulator.

10. The jacketed mixing vessel housing of claim 1, wherein the three jacketed side walls are arranged to at least partially enclose a mixing vessel.

11. The jacketed mixing vessel housing of claim 10, wherein the base is configured to support the mixing vessel when present within the jacketed mixing vessel housing.

12. The jacketed mixing vessel housing of claim 1, wherein the inlet and outlet of the jacketed mixing vessel housing are in fluid connection with a fluid source configured to be heated and/or cooled by a heating/cooling unit.

13. A bioprocess mixer system, comprising:
(a) an enclosure body holding the jacketed mixing vessel housing of claim 1;
(b) a mixer drive system comprising:
i) a drive system; and
ii) a drive housing containing the drive system and comprising a seat for a mixer base assembly comprising an impeller configured to be driven by the drive system.

14. The bioprocess mixer system of claim 13, wherein the mixer base assembly comprises:
(a) a mixer base body having:
(i) an upper end including a mating face for mixing vessel connection;
(ii) a lower end including a cavity;
(iii) one or more side walls;
(iv) an inlet port arranged in one of the one or more side walls;
(v) an outlet port arranged in one of the one or more side walls;
(vi) at least one probe port arranged in one of the one or more side walls;
and,
(vii) a fluid mixing chamber having a bottom wall;
(b) an impeller seat arranged in the cavity in the lower end of the body; and
(c) the impeller arranged in the impeller seat.

15. The bioprocess mixer system of claim 13, comprising the mixer base assembly in the seat.

16. The bioprocess mixer system of claim 13, wherein the impeller is a levitating magnetic impeller comprising a magnet, a base, and at least two blades.

17. The bioprocess mixer system of claim 13, wherein the enclosure body is positioned above the mixer drive system.

18. The bioprocess mixer system of claim 13, further comprising a probe support holder mounted to the enclosure body.

19. The bioprocess mixer system of claim 13, wherein the enclosure body further comprises an inlet port in fluid connection with the inlet port of the jacketed mixing vessel housing and an outlet port in fluid connection with the outlet port of the jacketed mixing vessel housing.

20. The bioprocess mixer system of claim 13, further comprising a weighing system configured to weigh an amount of process fluid within the mixer base assembly.
